(19) United States
(12) Patent Application Publication
(10) Pub. No.: US 2016/0165192 A1
(43) Pub. Date: Jun. 9, 2016

(54) METHODS, SYSTEMS, AND APPARATUSES FOR CAPTURING AND ARCHIVING FIREARM EVENT TELEMETRY AND ENVIRONMENTAL CONDITIONS

(71) Applicants: Amirbahman Saatchi, Savannah, GA (US); Aurash Kheradmandi, Savannah, GA (US)

(72) Inventors: Amirbahman Saatchi, Savannah, GA (US); Aurash Kheradmandi, Savannah, GA (US)

(21) Appl. No.: 14/963,220

(22) Filed: Dec. 8, 2015

Related U.S. Application Data
(60) Provisional application No. 62/124,118, filed on Dec. 8, 2014.

(51) Int. Cl. H04N 7/18; H04N 5/232; H04N 5/92; H04N 5/225; H04Q 9/00; H04N 5/77

(52) U.S. Cl. CPC H04N 7/185; H04Q 9/00; H04N 5/77; H04N 5/9202; H04N 5/2252; H04N 5/232; H04Q 2209/40; H04Q 2209/84; H04Q 2209/82

(57) ABSTRACT

In accordance with embodiments disclosed herein, there are provided mechanisms, methods, systems, and apparatuses for capturing and archiving firearm event telemetry and environmental conditions. According to a particularly described embodiment, there is, for example, a method executing within a device having at least a processor and a memory therein and being physically coupled to a weapon, wherein the method includes operating a proximity sensor at the weapon, the proximity sensor to trigger an activation event upon removal of the weapon from a weapon holster; detecting the activation event and triggering event archiving; archiving event data by storing event data to the memory of the device; and uploading the event data to a remote storage separate and distinct from the device. The weapon may be a lethal or a non-lethal weapon. In a related embodiment, there is a device capable for mounting to weapon, the device including at least a proximity sensor to trigger an event upon change in status of the weapon from a holster or to a holster; an audio capture device; a video capture device; a solid state memory to store captured audio, video, and event telemetry data; and a wireless communications interface from the device to a remote location having storage capability distinct from the device. Other related embodiments are described.

### CLAIM OF PRIORITY

This application is related to, and claims priority to, the provisional utility application entitled “METHODS, SYSTEMS, AND APPARATUSES FOR CAPTURING AND ARCHIVING FIREARM EVENT TELEMETRY AND ENVIRONMENTAL CONDITIONS,” filed on Dec. 08, 2014, having an application No. of 62/124,118 and Attorney Docket No. “Pro Se—Justifier,” the entire contents of which are incorporated herein by reference

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the field of firearm telemetry, and more particularly, to methods, systems, and apparatuses for capturing and archiving firearm event telemetry and environmental conditions.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

The increased tension created by firearm related deaths, as well as the sheer volume of firearm related incidents has created a social divide and a large grey area in social accountability pertaining to firearms as a whole. The effects are felt on both sides of the issue and cross over both the private and public/governmental sectors. Described herein are the means to provide the necessary evidence to give answers and accountability to both parties involved in a firearm related incident by and through the methods, systems, and apparatuses for capturing and archiving firearm event telemetry and environmental conditions as are described herein.

Surveillance cameras can aid in proving or disproving innocence or guilt. Video captured by such surveillance cameras can serve as evidence. While surveillance cameras are common, they are not everywhere, nor are they always positioned ideally to record the situation in question with respect to firearm related incidents. Described means provide systemic evidential capture, recording, and archiving to facilitate a legal conclusion after firearm related incidents, especially those resulting in injury or fatality caused by a firearm.

No means presently exist in the market place or the state of the art for capturing and archiving firearm event telemetry and environmental conditions.

Described herein the technological means to provide a substantial account of a firearm involved incident. The described technology fills a void in the marketplace and will provide clarity to firearm related incidents. Further described are means to establish large scale manufacturing capabilities for providing the methods, systems, and apparatuses which embody the described technology to municipalities, police forces, security firms, retail business, and individual consumers.

The present state of the art may therefore benefit from the methods, systems, and apparatuses for capturing and archiving firearm event telemetry and environmental conditions as is described herein.

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIG. 1 depicts an exemplary view of a weapon having an embodiment of the device mounted thereupon;

FIG. 2A depicts an embodiment of the device having been mounted to a weapon via a tactical rail;

FIG. 2B depicts another embodiment of the device having been mounted to a different weapon via a tactical rail;

FIG. 3A depicts an embodiment of the device now having an alternative shape and having been mounted to a weapon via a tactical rail;

FIG. 3B depicts an embodiment of the device having another alternative shape and having been mounted to a weapon via a tactical rail;

FIG. 4 depicts an embodiment of the device now having been mounted to a concealed weapon and holstered with the device attached to the weapon;

FIG. 5A depicts an embodiment of the device sliding onto a tactical rail of a weapon;

FIG. 5B depicts an embodiment of the device sliding onto a tactical rail of a weapon;

FIG. 6 depicts an embodiment of the device configured for a particular business product including proposed lens fidelity, battery size, and video format;

FIG. 7A depicts an embodiment of the device with selected components for inclusion as a single package with a gun;

FIG. 7B depicts another embodiment of the device with selected components for inclusion as a single package with a gun;

FIG. 8 depicts an embodiment of the device as depicted with differing shapes and form factors;

FIG. 9 depicts alternative embodiments of the device as depicted with differing shapes and form factors;

FIG. 10A depicts an embodiment of the device having laser and spotlight control mechanisms;

FIG. 10B depicts an embodiment of the device having laser and spotlight control mechanisms;

FIG. 11A depicts an embodiment of the device with a drawer and spring mechanism;

FIG. 11B depicts an embodiment of the device with a drawer and spring mechanism;

FIG. 12 depicts an embodiment of the device as prototyped with night vision video capture capability and other described features integrated therein;

FIG. 13 depicts an embodiment of the device as prototyped with described functionality;

FIG. 14 depicts an embodiment of the device having a cap that can screw, glue or hang and fix upon the weapon with grips arms;

FIG. 15 depicts an embodiment of the device in a section view;

FIG. 16 depicts an embodiment of the device in a top section view;

FIG. 17 depicts an embodiment of the device with an inner components view;

and

FIG. 18 depicts an embodiment of the device in an exploded view.

### DETAILED DESCRIPTION

Described herein are methods, systems, and apparatuses for capturing and archiving firearm event telemetry and environmental conditions, for example, to provide a substantial account of a firearm involved incident without requiring human intervention to initiate, capture, and archive such firearm event telemetry and environmental conditions, which may include, for example, audio, video, orientation, time, date, and other relevant conditions.

According to the various embodiments, such means may include an apparatus or other firearm device with integration of a Micro Camera which may optionally include night vision features, as well as an audio capture device such as a microphone. According to some embodiments, additional features may be integrated into such a device including, for instance, a spotlight and laser sight or a laser sighted scope.

The apparatus may be useful for defending against crime and as well as providing self defense and evidence of self defense. Such a device may be set or mounted upon hand guns (e.g., pistols, 9 mm's, etc), rifles, and other firearms. The device may prove valuable to hand-gun users as well as rifle users alike as the device is capable of capturing both video and audio as well as other telemetry data which may be of interest to a wide variety of user types including citizenry which carry weapons for self defense, hunters, target shooters, and so forth. Military and police configurations are likewise contemplated and described below as the data may prove valuable for documenting appropriate use of force for police and military personnel alike when in the event a gun related incident is called into question. Moreover, the device may be configured to interact and communicate with remote elements as will be described in further detail below, which thus enables more sophisticated weapons training and tactics and in-situ decision making and communications by command based on telemetry data provided at and by the weaponry of individual soldiers, SWAT team members, police, and so forth.

The device may likewise be mounted upon non-lethal weaponry for entertainment or for documenting incidents. For instance, non-lethal “paint ball” guns may be utilized with the device to document the area of play or sequencing of events or for score validation and verification in competitive play.

Similarly, the device may configured for appropriate use with non-lethal weaponry such as mace, pepper spray, tasers, bean-bag shotguns, rubber pellet and rubber bullet shooters, tear gas launchers, and so forth, so as to document the relevant telemetry and scene at the point and time of use.

The device enables persons in trouble to capture and record the situation and environmental conditions before a firearm is discharged as well as the capture of the situation and accompanying telemetry data in the event that the firearm is actually discharged. According to some embodiments, the device additionally enables the capture of a situation, environmental conditions, and telemetry even where the firearm is not discharged, as it may nevertheless be helpful to provide an account of, for example, why a firearm was drawn, readied and pointed, including what the gun was pointed at and the timing and sequence of events that lead to the readying of the firearm, even where it is ultimately re-holstered without firing. Such an account may be helpful in law enforcement applications, by way of example, so as to exonerate police activities which are commonly second-guessed after the fact by others in sometimes a total vacuum of information or other times with poor quality and non-controlled video graphic evidence produced from, for example, cell phone video, dash-cam video, surveillance video, etc.

In other instances, the device provides means by which a person in trouble, who elects to fire a weapon, regards their decision in the context of self defense in case of such an emergency where the urgency simple would not otherwise allow for the capture of such events and associated data. However, the device is configurable to seamlessly, and without requiring the user's intervention, capture and record the series of events before the shooting and ultimately the shooting itself, with the audio, video, and other telemetry as appropriate of the implementation being archived onto storage media (e.g., memory, solid state memory, SD card, etc.) within the device. Such records would provide strong evidence and an indisputable first hand account of the events surrounding the firearm event before a court of law.

According to one embodiment, a camera activates upon an event trigger corresponding to a weapon being drawn from a holster. The auto trigger permits the camera to immediately being recording and archiving video, audio, and other data well before the gun is discharged. In other alternative events, a trigger could be established for when the weapon is made ready by taking off the safety, or when the gun is held, or when a gun is raised, or any number of other detectable environmental triggers and/or events. In some embodiments, the event trigger is user selectable whereas other implementations may require the trigger to non-customizable so as to prevent tampering. Using the determined event the device may then activate whatever sensors are appropriate, such as video, audio, sight, etc.

According to the various embodiments, a variety of sensor mechanisms may be utilized, such as sensors which are now commonplace within smart phones (e.g., such as sensors that sense touch or automatically activate a display screen function, etc.). For instance, when the iPhone's sensors are in close proximity to an ear or hand, the display screen is deactivated or activated as appropriate.

Power and connectivity to the device are provided via rechargeable battery power which may be charged by through an adapter over USB or to a computer or a wall outlet, etc. A USB compatible port in the device is utilized to connect to a computer and transfer data to a new location. Other embodiments utilize wireless technology such as a WiFi transceiver, a Bluetooth transceiver, and/or a 3G/4G transceiver.

According to the various embodiments, a laser sight and spotlight may be activated via a mechanical button, key, or toggle, or may be activated via software, such as upon a detectable event trigger as described above.

According to the various embodiments the device is environmentally hardened or ruggedized for use in hostile operating environments such as conflict zones or urban environments where police are likely to operate. For example, the device may be waterproof and/or crafted from hard black Polymer or other materials which are preferred amongst gun manufacturers.

According to the various embodiments the device mounts to a pistol or rifle via standardized tactical rails above or under the barrel of the firearm depending on the design and application.

Certain embodiments operate with data storage, cloud storage, and data archiving technologies which may include, for example, client-server implementations, computing grids, computing pods or pools of work machines, traditional databases, single tenancy database systems and/or multi-tenant database systems.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

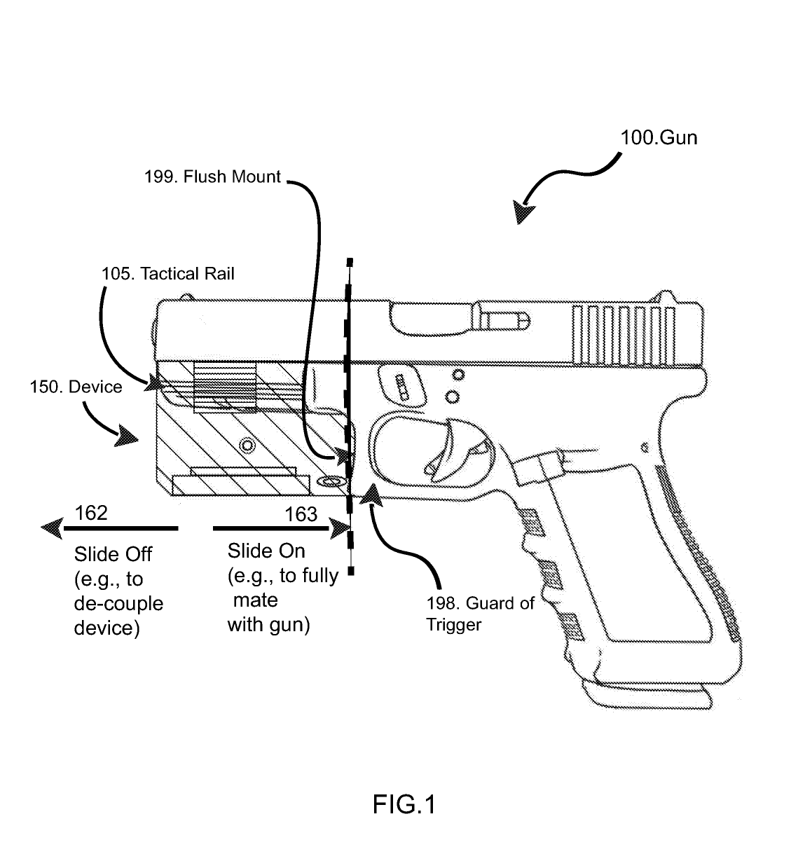

FIG. 1 depicts an exemplary view of a weapon (gun 100) having an embodiment of the device 150 mounted thereupon.

In particular, there is depicted a gun 150 having a tactical rail 105 for which there is device 150 matched and mounted to the tactical rail 105.

Tactical rails 105 are similar for all guns. For instance, the “Picatinny” rail, also known as a MIL-STD-1913 rail, Standardization Agreement 2324 rail, or “tactical rail” as is referred to herein, is a bracket on many firearms that provides a standard mounting platform consisting of rails with multiple transverse slots. Such a tactical rail is similar to the earlier commercial “Weaver” rail mount used to mount telescopic sights on many guns and rifles.

The Weaver design is utilizes a low wide dovetail whereas the Picatinny variation has a more pronounced angular section. Each are capable to mount heavy sights of various kinds and a wide variety of accessories and attachments (e.g., such as, besides device 150; vertical ‘tool’ or ‘pistol’ grips; bipods and rests; electro-optical sights including image intensifiers; flashlights and laser sights which may be mounted by sliding into place (or if already fitted with a Weaver style mount clamped to the tactical rail), thus providing backward compatibility with items already provided with Weaver-type mounts; etc.). Many kinds of attachments exist in the marketplace today for civilian, policing, and military applications.

We refer herein to the tactical rail generally as it is not the focus of the claimed embodiments, with the claimed device 150 simply leveraging existing mounting tactical rail technology to mount the device 150 according to certain embodiments. Nonetheless, the tactical rails in the market place today consist of at least a “receiver” portion and a “tool” portion which matches or mates to the receiver portion. Regardless of the design, style, position, or configuration of the tactical rail, the device 150 as described and claimed herein is configurable to accept and utilize both existing and future tactical rails so long as the tool or receiving portion of such tactical rails may be affixed to the device 150.

In other embodiments, no tactical rail tool or receiver is utilized. Rather, the device may be manufactured as part of a gun or rifle or other platform or the device may be integrated post-manufacturing onto such a gun or rifle or other platform in a permanent or semi-permanent configuration which does not utilize the tactical rail concept. For instance, it may be preferable for police or military weaponry to use a permanent non-tactical rail integration whereas civilian consumers are perhaps more likely to prefer and thus choose a tactical rail mounted device 150.

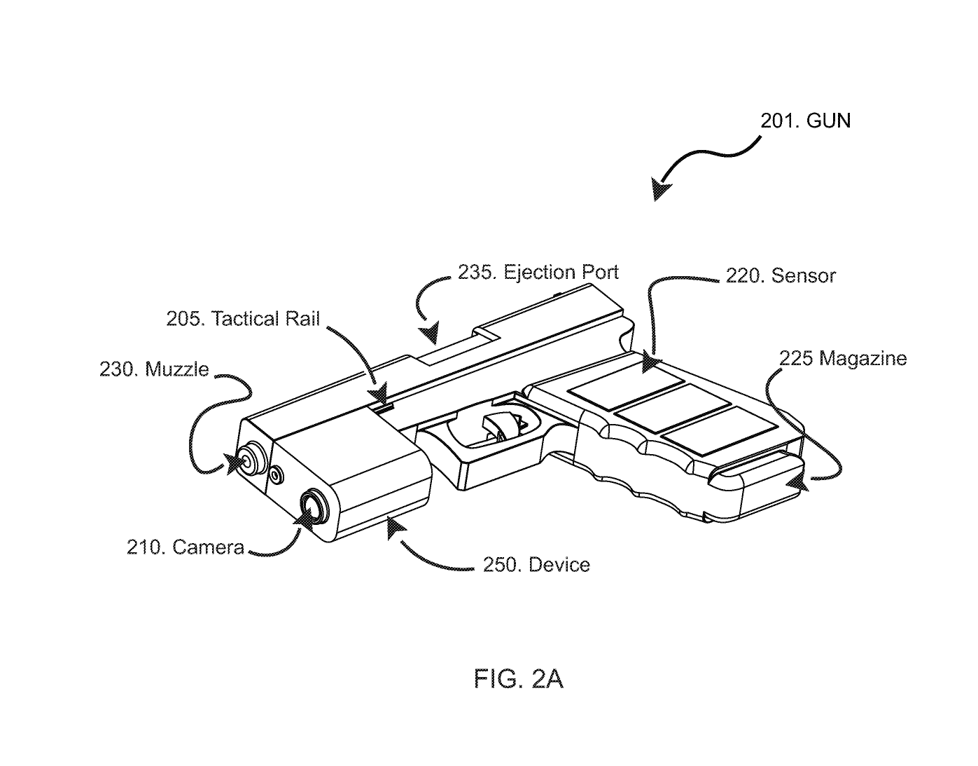

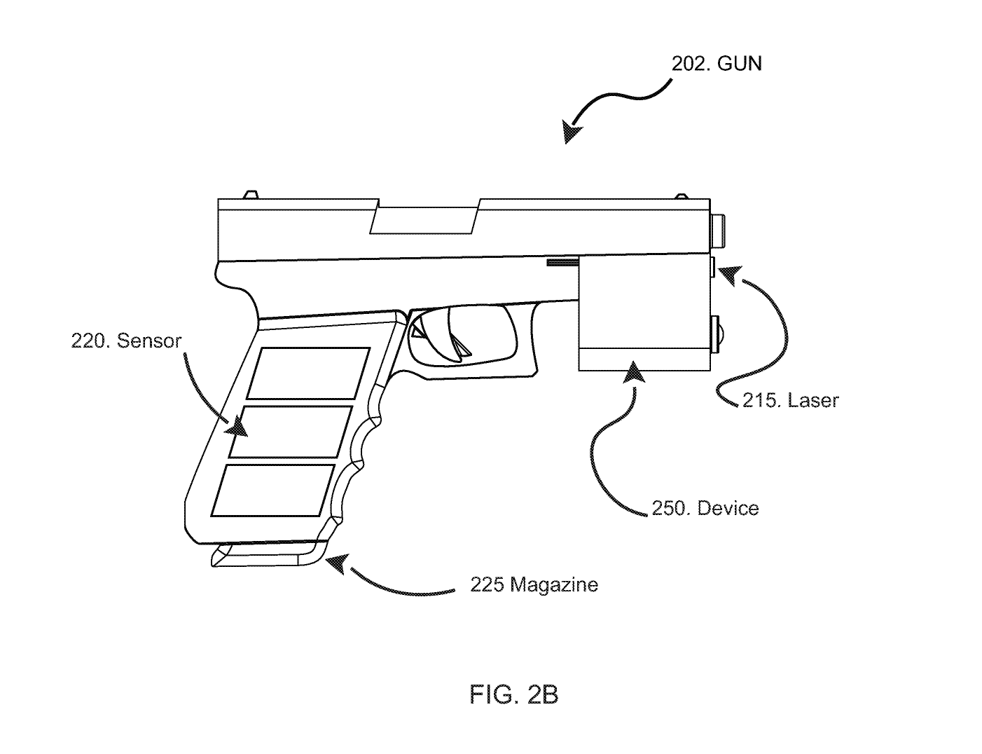

With reference back to gun 100, used here as an exemplary platform for device 150, the depicted embodiment shows how the ergonomics of the gun 100 may be accommodated by device 150 which permits the device 150 to slide in and out so as to mount the device 150 on the gun and also the grip of the tactical rail to be held fast to the gun. As is particularly depicted, device 150 may slide on 163 to gun 100 to fully mate with the gun, such that the device 150 is coupled to the gun via tactical rail 105. In a complementary fashion, device 150 may slide off 162 of gun 100 to decuple device 150 from the gun 100. Use of the term flush mount is in reference to a face of the device 150 being customized in such a way that the shape of device 150 matches a contour of the gun 100 or other weapon to which it is mounted, such as the face of the device 150 which is shown adjacent to and mating with the forward facing face of the gun's 100 trigger guard 198 on the particular embodiment shown. Compare this to FIG. 2 which is not flush mounted. In such a way, despite the gun 100 having one manufacturer and the device 100 having a separate and distinct manufacturer, and possibly, no business agreement or cooperation between them, the device 150 may nevertheless be configured and provided to the consumer in such a way as to have a seamless transition from the gun 100 to the device 150 as though it were a single unit, despite being separate components. This may be particularly important for police forces and military use where the smooth transition aids in gun handling safety and a non-intrusive use for the sake of the officers' or soldiers' safety as it is of critical import that their extensive training and comfort and skill wish such weaponry not be undermined by an ill-fitting accessory which despite its obvious benefits, is not part of the gun's 100 primary function which is to, of course, protect the life and safety of those in our service, specifically, the brave police officers and soldiers who put themselves in harm's way.

Further depicted is the concept of the aesthetics of the device will follow the same lines as the gun with this particular embodiment depicting device 150 having a flush mount 199 at a rear face of device 150 to the guard 198 of the trigger of the gun (e.g., flush mounted to the trigger guard) so as to have a seamless transition between device 150 and gun 100, regardless of how or when procured by a user. For instance, it is likely that the gun 100 is manufactured by a first entity and the device 150 is manufactured by a second entity, yet both may nevertheless be part of an aesthetically pleasing package when paired by a user.

For instance, a 9 mm Smith and Wesson may thus be matched in terms of the lines on the device and the color and the texture; it can be matched to silver or black or stainless steel or it can be customized on a per-customer basis. The contour of the device may likewise be matched to the physical contour of the exemplary Smith and Wesson gun. The aesthetics themselves do not affect the functionality of the gun 100 or device 150, but they do provide for a more aesthetically pleasing experience for the customer. It is contemplated also that the aesthetics of flush mounting the device 150 to the gun carry a functional advantage over accessories mounted onto guns via tactical rail 105 as the flush mounted device 150 is far less likely to snag or catch on a holster or clothing and may thus prove safer and more efficient in terms of draw and readying the weapon compared to an otherwise identical device which lacks the ability to be flush mounted by the flush mount 199 face of device 150 matched to gun 100.

Specifically, element 199 shows the flush mount surface where the backside of the device 150 follows the contour of the gun 100. For instance, shown here, device 105 matches the contour of the front of the trigger guard 198 where it matches the back of the device 150. The trigger guard 198 is behind the tactical rail 105 in this particular embodiment, however, other configurations are accommodated based upon the particular gun 100 manufacturer's design and placement of the tactical rail 105. For instance, the tactical rail is customarily but not necessarily top mounted on most hunting rifles to accept an optical scope whereas other rifles include multiple such tactical rails, each of which are capable of accepting and mounting the device 150 depicted. For instance, rifles may include a bottom facing tactical rail to accept a tripod, a top facing tactical rail to accept a scope, and side face tactical rails to accept additional accessories.

The device 150 as shown mounted presently on gun 100 has the capability to capture and record voice, ambient noises, and the imagery of a scene within the field of view of the device.

Depicted here device 150 is mounted on a Pistol 9 mm but may be mounted to a wide array of weapons. Device 150 as depicted here includes as per select embodiments camera, microphone, spotlight and laser thus permitting the capture and recordation of strong evidence before, during, and after weapon discharge as well as during weapon's use and pointing regardless of whether or not weapon is discharged.

Various configurations are described herein some of which are user selectable (e.g., mode of operation) where as other configurations are selected and chosen by a non-user entity, U.S.C. as according to police department policy or military specification and requirements, each of which may dictate a configuration which is to record audio and video regardless of weapon discharge, etc.). Civilian consumer configurations by comparison are likely to permit the user to choose whatever mode of operation they wish as they would not fall within the operational purview of such police and military policy requirements.

FIG. 2A depicts an embodiment of the device 250 having been mounted to a weapon (e.g., gun 201) via a tactical rail 205. FIG. 2B depicts another embodiment of the device 250 having been mounted to a different weapon 202 via a tactical rail 205.

Depicted here is device 250 having been mounted on a different type of gun 201, specifically, one for which a tactical rail 205 is provided as part of the gun platform to receive the device 250 but for which there is no flush mounting of the device 250 to the gun 201.

Matching device 250 is feasible to all types of guns 201 and 202 so long as the devices have a tactical rail 205 to receive the device 250. Within device 205 is camera 210 to capture still and video imagery from a scene within the optical view of the camera 210 of device 250. Also shown is laser 215 for visual aiming. According to one embodiment the laser emits light in a visible range and is used for aiming and also as a deterrent and intimidation. According to another embodiment, laser 215 emits light in an infrared range and works in conjunction with an infrared detector or an infrared camera. In such an embodiment, the infrared camera is utilized by triangulation functionality to detect the range or distance to an object in the scene. In other embodiments, two cameras which operate in the visible light range (e.g., RGB, Red Green, Blue cameras) are utilized simultaneously at a known baseline distance from one another and depth to an object or target in the scene within the field of view of the cameras is determined on the basis of correspondence.

For instance, distance to an object or target in the scene within the field of view of the cameras may be calculated to a target in certain use cases or distance may be calculated to a person in the scene at whom the gun is aimed. Such telemetry data, specifically the distance to a human at which the gun is aimed, may be critical data subsequently in the event of an inquiry or investigation and may very well provide quantifiable evidence of grounds for self defense or appropriate use of lethal force in the event of a police officer involved shooting or a police officers use and aiming of a gun, whether or not the firearm is discharged.

Sensor 220 at the rear of gun 202 is shown which is capable to sense the presence of a hand by temperature differentiation and initiate functions of the device 250. For instance, when a user grabs the gun, even while holstered, the device 250 may be configured to begin recording, as triggered by the sensor 220 detecting that a hand has gripped the gun 202.

Magazine 225 at the back of gun 201 and 202 holds ammunition for the gun. Muzzle 230 is shown as is the ejection port 235 of the gun.

Device is shown mounted on pistol 9 mm by using tactical rail 205. The device slides onto the pistol tactical rail. The device shape is easily adapted to many different physical form factors of guns, rifles, shotguns, and non-lethal weaponry utilized by police forces such as bean-bag guns and stun-guns. Many guns have convenient tactical rails, however, other devices may be mechanically coupled using well known conventional techniques without distracting from the described embodiments. In accordance with certain embodiments, a supplier provides the functional components to a manufacturer who integrates them into a firearm or non-lethal weapon at the point of manufacture whereas other embodiments bring the device and weapon together for physical coupling after manufacturer and after sale, for instance, by a home owner or by a local police force or by a military unit, etc.

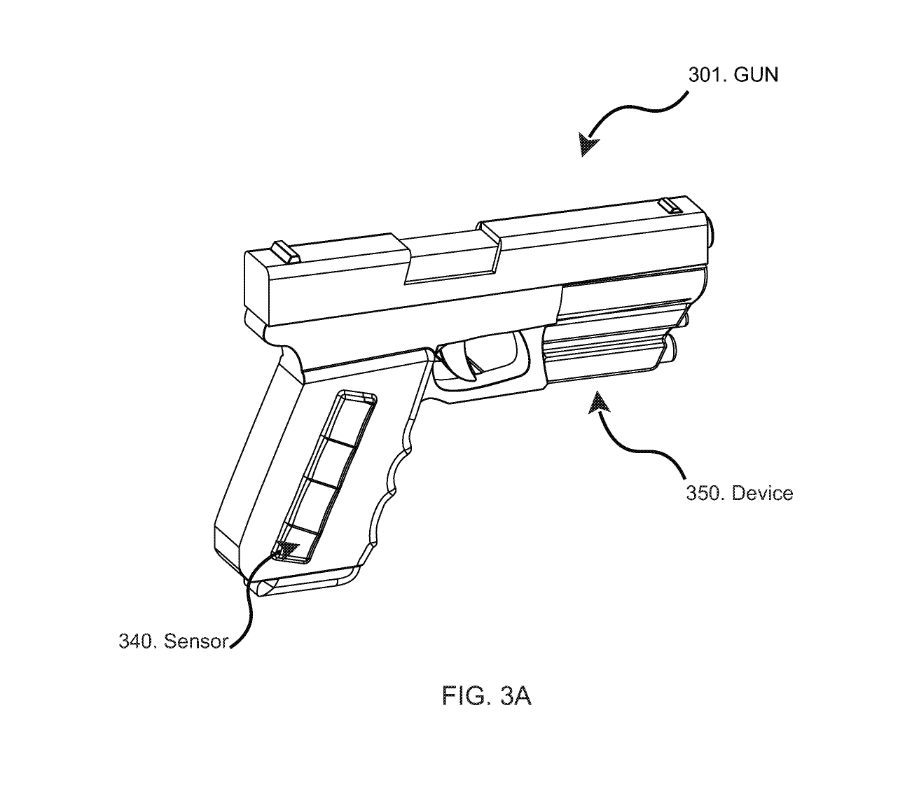

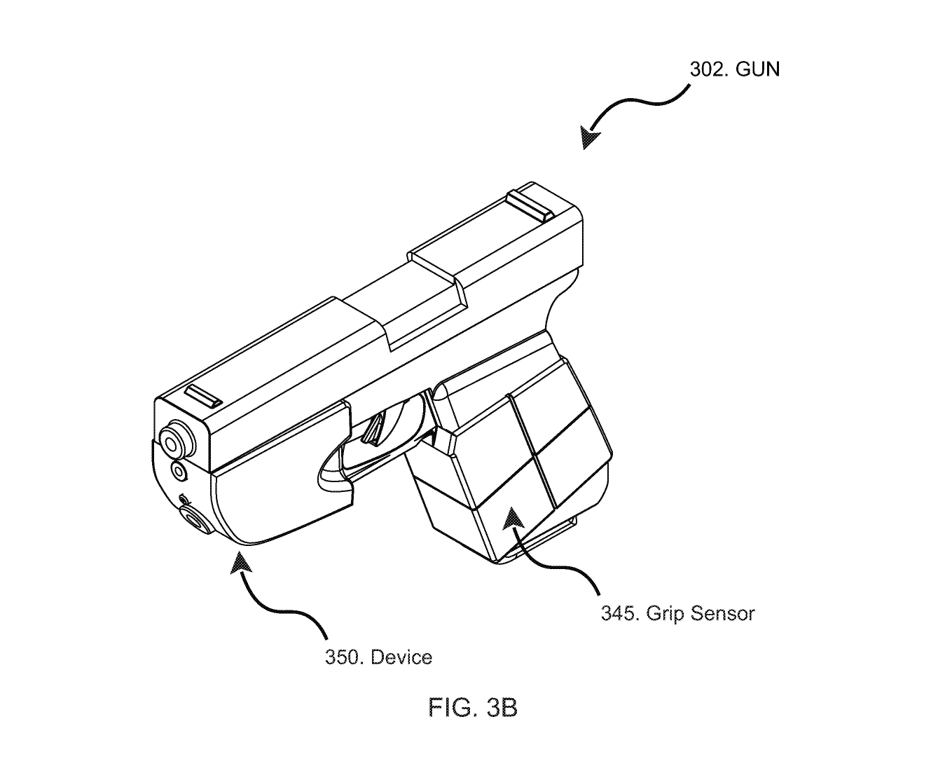

FIG. 3A depicts an embodiment of the device now having an alternative shape and having been mounted to a weapon via a tactical rail and FIG. 3B depicts an embodiment of the device having another alternative shape and having been mounted to a weapon via a tactical rail.

Sensor 340 can take on different shapes, for instance, gun 301 depicts a sensor 340 having a vertical orientation when the gun is in a horizontal (e.g., raised, aimed, or readied) position, so that it may detect the presence of a user's palm. Conversely, on gun 302 there is depicted a grip sensor 345 in a different position, shown with the sensor 345 being on the front of the grip capable to sense the user's fingers, and in which the sensor 345 senses the presence of a human user on the basis of pressure from the user's hand when holding or griping the firearm. The sensors 345 and 340 may use temperature, pressure, proximity, electromagnetic proximity, or any other means by which to detect the presence of a user's hand griping or holding the weapon.

Likewise depicted is the device 350 having different physical shapes to match the contour of the depicted pistol firearms.

Device 350 is mounted on pistol by using tactical rails according to certain embodiments but may be mounted by other means. For instance, where a manufacturer incorporates the device 350 the device may be mechanically coupled with the gun or fused to the gun, glued to the gun, chemically bonded to the gun, or integrated into the chassis or modified muzzle of the gun. In other embodiments, such as where the device operates in an always-on mode per police department or jurisdictional policy, the device 350 may be mounted not with a standardized tactical rail, but with a mechanically locking tactical rail or a customized tactical rail which permits the device to be installed but never removed, or permits the device to be installed by only removed with a key, etc., based on the particular needs and requirements of the police force or governmental body setting the policy for its force and officers.

Device 350 may be customized and designed in various shapes and concepts. It can follow pistol's body curves and crease lines and matches and merge to pistol's figure. Functionality and operation may remain static while physical form factor is specifically adapted to fit various weapons on behalf of or in conjunction with weapon manufacturers, with military contract specifications, with police or governmental bodies setting such standards, and so forth.

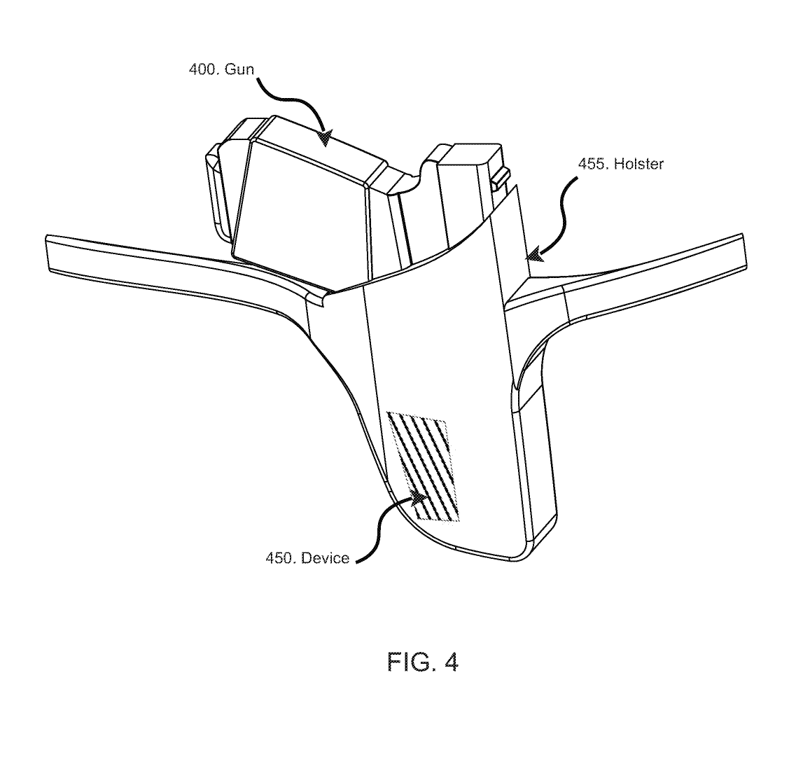

FIG. 4 depicts an embodiment of the device 450 now having been mounted to a concealed weapon and holstered with the device attached to the weapon 400.

In particular, there is depicted a special holster 455 in which not only the shape of the gun is accommodated but also the shape of the device 450 as mounted on the gun 400. As depicted, the holster 455 may take on a different shape to accommodate the different shape of varying firearms having the device 450 mounted thereupon. The manufacturers of such firearms commonly manufacture holsters to match the contour of the gun that they produce, however, the device 450 when mounted changes the shape of the gun resulting in a manufacturer's original holster no longer working or fitting their own gun. Aftermarket holsters are commonplace and they may likewise be created to accommodate the shape of a manufacturer's gun with the device 450 mounted thereupon. Device is mounted on concealed weapon (e.g., depicted here a pistol 9mm) in a specifically customized holster to accommodate a gun 400 having the mounted device 450.

Specific holsters 455 for pistols 400 having such a device 450 mounted thereupon is therefore provided so as to accommodate change in shape and negate need for removal of the device 450 from the weapon 400 which would otherwise discourage consistent use and operation of the device 450, which is especially critical in policing activities where the device may very likely serve to exonerate the justifiable actions and split second decision making by an Officer in a gun related incident.

Further depicted is the proximity sensor in the grip but which may be located elsewhere on the gun 400. While device 450 and pistol 400 are in the holster the proximity sensor is off according to certain embodiments and thus, the camera and microphone is deactivated. This is the most likely configuration and operation, though it is configurable to operate in other modes. In such a configuration, when the pistol is drawn out of holster the proximity sensor detects the change in state (e.g., without regard to the presence or non-presence of a human hand) and the device 450 is automatically activated, therefore camera and microphone start working. In other embodiments, the camera and microphone operate continuously along with telemetry capture and sensing but in a in a low resolution and low power state but are buffered, for instance, to a 3 second, 5 second, 20 second, 30 second, 1-minute buffer etc., based on the use and storage capacity included with device 450, such that drawing the gun causes the buffered telemetry data and audio and video to be immediately archived such that a period of time up to and equal to the amount of video, audio, and telemetry data buffered, may be captured prior to the proximity sensor event. In such a way, not only is audio and video and telemetry data available from the time of draw, say time 0 through the raising, readying, and aiming of the gun, say time 1, and through the firearm discharge, say time 2, and ultimately the results of a targeted weapon being fired, say time 3, but also, the audio (perhaps muffled due to the holster) and video (perhaps dark due to the holster blocking light) and telemetry data (likely valid despite being holstered as the holster doesn't interrupt operation of gyroscopic sensors and accelerometers and GPS and other data collected) is captured before time 0, say time −1, due to the buffer cycle operating within the device 450. For instance, the audio, video, and telemetry data may be cycled through a FIFO (first in first out) buffer which constantly buffers a portion of data which is then simply de-buffered without persisting it to non-transitory storage, such as to the SD card, etc., but then upon a proximity sensor event or other event trigger configurable for the device 450, the buffered data is output and persisted to the non-transitory storage, for instance, to an SSD or SD card, etc., for permanent archival. Such data my then be retrieved from the gun by way of a data jack, USB interface, or 3G, 4G, WiFi, blutooth, or other communications technology to a cloud based server or other off-gun storage facility for archival purposes.

According to certain embodiments, the device is integrated at or by a manufacturer and sold as a complete unit to police departments and other field applications. In other embodiments, the device is sold as a separate unit but locked/secured to the unit in such a way that it cannot be removed by the end-user. For instance, a uniformed police officer may be the end user but is not able to remove or modify or deactivate or re-configure the unit, whereas a weapons custodian or other responsible party may have the ability to acquire, configure, install, de-install the device, as per department policy.

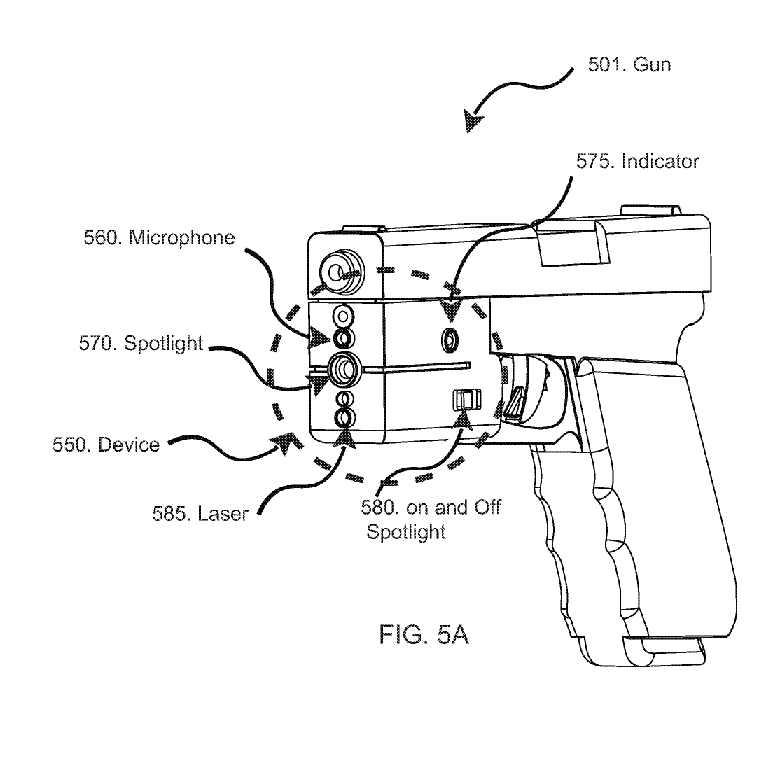

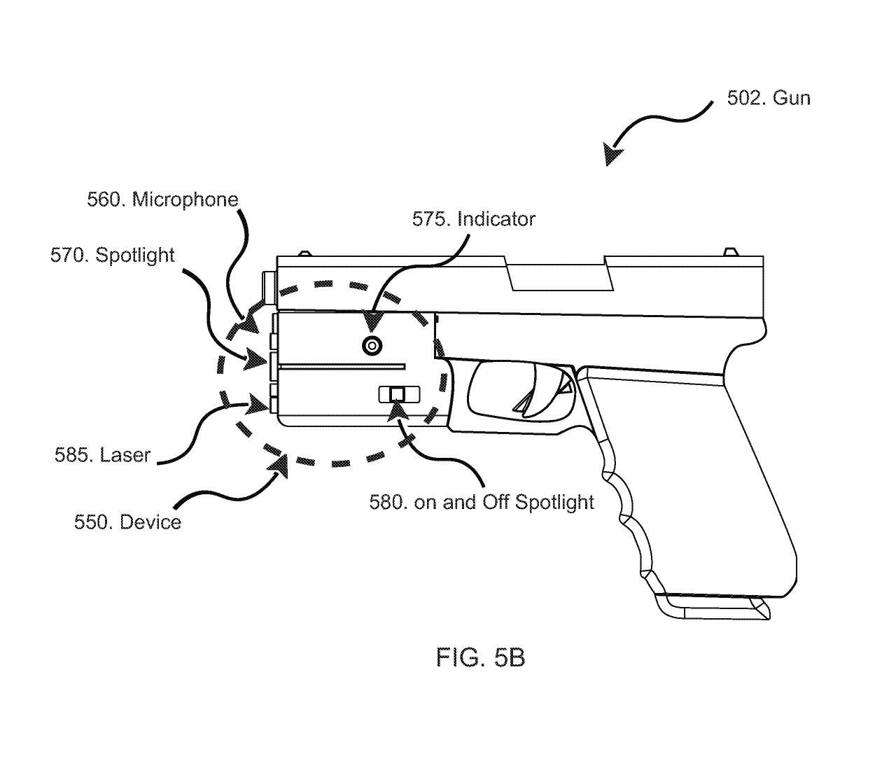

FIG. 5A depicts an embodiment of the device sliding onto a tactical rail of a weapon 501 and FIG. 5B depicts an embodiment of the device sliding onto a tactical rail of a weapon 502.

Weapon 501 is mounted with device 550 having microphone 560 integrated therein to capture audio from a scene at the device 550 which may include voice data from a police officer or a perpetrator or voice data from a consumer/user, audio of the weapon discharge, and other ambient noise information in the scene within capture range of the microphone. Spotlight 570 is depicted to provide additional light in the visible range in the scene originating from the device 550. Indicator 575 is depicted showing how much battery charge remains for the device 550 via a color LED, digital readout, or other appropriate means based on the configuration. For instance, certain military platforms require a lights-out or invisible operation and as such, there cannot be any luminescence emitted from the device 550 even while in active operation and actively recording. On/Off switch 580 is used to turn the spotlight 570 on and off respectively. Laser 585 is again depicted here which may be configured for the device 550 in the visible or infrared range, or both as may conceivably be called for by certain customers and use cases.

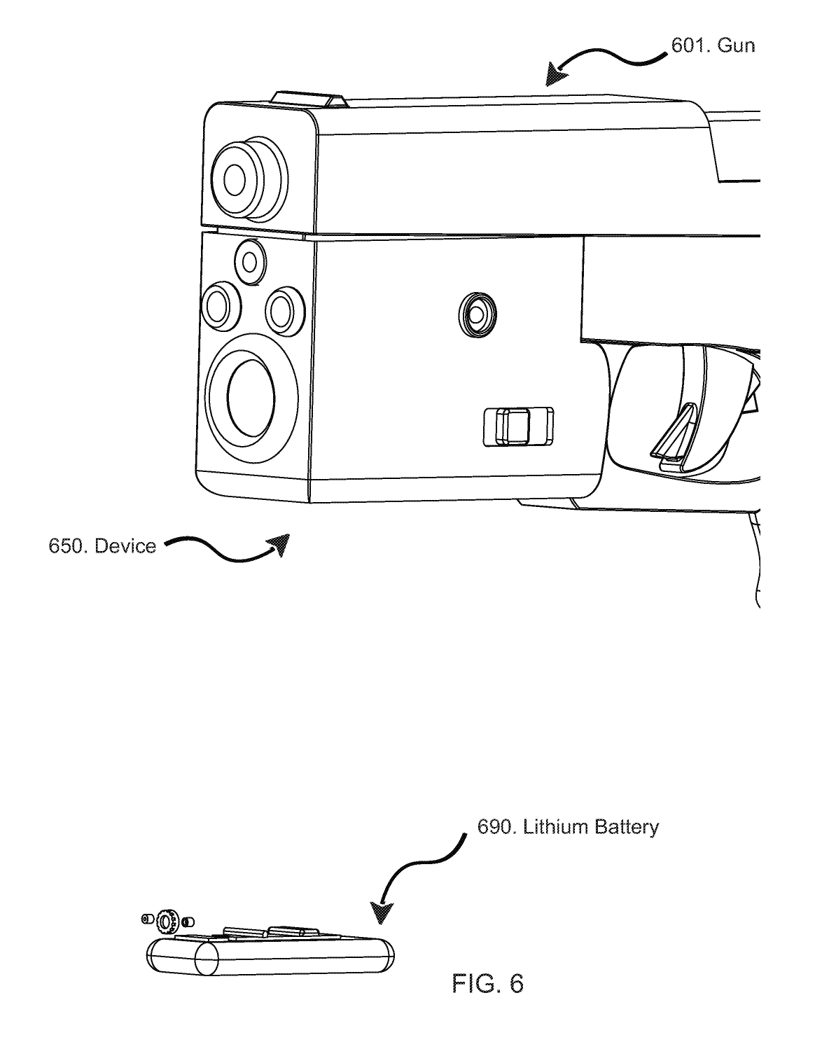

FIG. 6 depicts an embodiment of the device 650 configured for a particular business product including proposed lens fidelity, battery size, and video format. For instance, government specification, military contract, or popular consumer usage may call for certain video modes (e.g., resolutions, frames per second speed, lens optics configuration (e.g., wide, narrow, far/near, etc.), video formats (e.g., mpeg, mkv, etc.) battery capacity for hours of continuous operation without charge, and so forth.

Here a lithium battery 690 is depicted which provides electrical power to the device 650. Internal solid state memory for video, audio, and event telemetry capture may be removable, for instance, by home user applications (for instance, a micro-sd card may be removable and replaceable) or the storage/sd card/ssd may be made fixed and non-removable so as to prevent tampering, for instance, as with police and other government sanctioned use as per policy of the police force or governing regulations.

In certain embodiments the lithium battery 690 serves as a primary battery and thus powers telemetry data only or powers telemetry data, audio, and video only. A secondary battery is dedicated then to a spotlight operation, such that overuse of the spotlight results in a dead battery for the spot light but not the telemetry or the telemetry and audio and video. Similarly, a third battery may be dedicated to the laser and/or night vision LEDs so as not to deplete the primary battery. Or the primary battery such as lithium battery 690 may operate for telemetry capture and audio/video capture and a single secondary battery is dedicated to all other functions. Where a secondary and/or third battery is present, the device 650 may be configured to draw power from the second and/or third battery for primary functions such as the telemetry capture and audio/video to preserve primary battery function.

In certain embodiments, the device is made to stream and auto upload or synchronize to a remote source when within range, for instance, the device may automatically upload audio, video, and telemetry event data to a storage location in a police vehicle or into the cloud so as to have an archive of the recorded information as imminently as possible. Data may be prioritized as per QoS standards such that event telemetry data is uploaded first without user intervention as its size is small and its value may be great, followed by audio, followed by video. In certain embodiments, an initial upload my be provided by the device to a remote location which provides the event telemetry data and a very low quality audio and video representation which is small in size, followed later by the highest-available version of the audio and video from the device. For instance, the device 650 may record in a high fidelity format but down-sample on the fly to provide a smallest possible representation of the audio/video to the cloud server or off-gun storage which is then replaced through the on-going synchronization process with the highest fidelity representation of the audio/video available. In certain embodiments, subsequent to synchronization of the telemetry event data and audio and video from the device as mounted on a weapon to a remote location the information is persisted at the remote location and deleted, overwritten, or otherwise removed from the device as mounted at the field weapon or firearm. For instance, synchronization of the gun 600 with an archival server may end with confirmation of the data being archived at the off-gun storage and then a deletion or removal of the on-gun data to clear storage capacity for new data. Alternatively, the gun may operate such that the on-gun storage capacity fills and then oldest data is simply over-written first.

Device 650 can be different shapes and include varying features at the request of the consumer, manufacturer, retailer, etc. Device 650 may be outfitted with a camera and microphone only in low cost models or outfitted such that there is integrated a camera, microphone, Spotlight, Laser and night vision, gyroscopic sensors, GPS, 3G/4G/LTE transceiver(s), blutooth, Wifi, etc., which adds cost, but which may be appropriate for certain platforms, such as military and police usage.

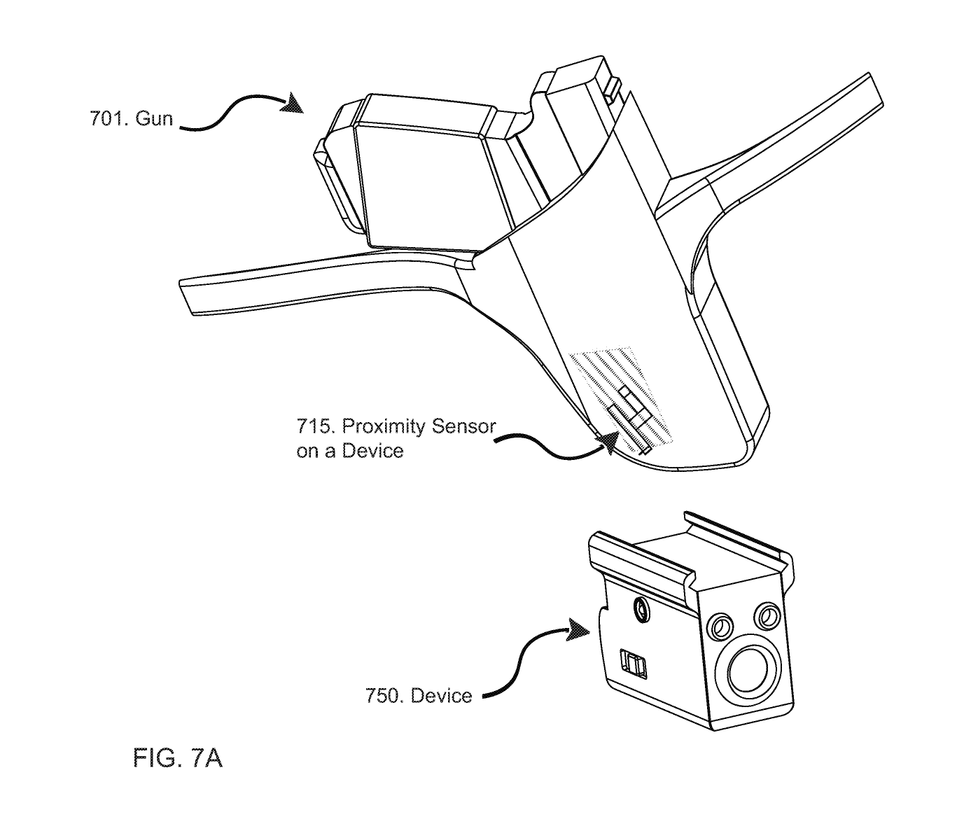

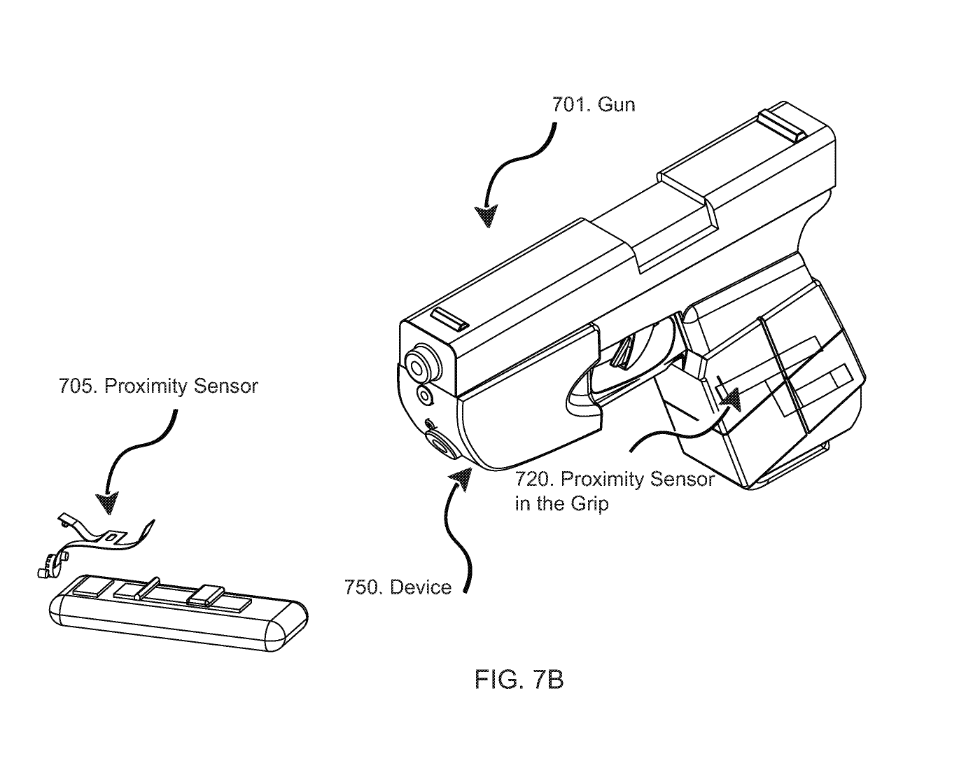

FIG. 7A depicts an embodiment of the device 750 with selected components for inclusion as a single package with a gun and FIG. 7B depicts another embodiment of the device 750 with selected components for inclusion as a single package with a gun.

Specifically, there is depicted a proximity sensor 715 integrated within device 750 which senses the presence of a user's hand such that the device 750 may be initiated or alternatively detects the removal of gun 700 from the holster. For instance, when the proximity sensor 720 integrated into a grip of gun 701 determines that a human user's hand has gripped the gun, the determination or trigger by proximity sensor 720 may be configured to initiate audio recording, video capture, telemetry archival, etc. According to a particular embodiment, the proximity sensor 715 is integrated into the device 750 and is utilized to turn the device 750 on and turn the device off. The proximity sensor 705 may alternatively or additionally be integrated into the device 750 as proximity sensor 715 which is mounted onto a firearm so as to turn the device 750 on and off when it determines that a user's hand is within sufficient range of the proximity sensor. Or the proximity sensor may trigger events (e.g., flushing a FIFO buffer to persistent storage and recordation of ongoing audio, video, and telemetry, etc. According to such embodiments, device 750 operates in a standby and low-power state and the proximity sensor 705 activates additional functions or causes functions running at a low power mode such as low resolution video and low fidelity audio capture to operate at a higher power mode when a user's hand is sensed within proximity of the gun, such as gripping, holding, or aiming, etc, or when the proximity sensor 705 determines the gun is removed from the holster, etc.

The proximity sensor 705 may similarly be utilized to record the time, place, location, etc. when an officer simply places his hand on the gun 701, even without the gun being removed. For instance, there are varying levels of threat to officers in the field and they may, per policy, training, etc., place their hand on their weapon an anticipation of a potential threat escalating. The officer may similarly unclip their weapon's holster to prepare the gun for faster removal which maybe determined by sensors and audio, and/or the officer may remove the safety on their weapon an anticipation of a threat, none of which requires the weapon to be removed from the holster, but all of which is relevant data especially during an inquiry to show an officer's actions were justified and appropriate.

Sadly, investigations into police officer deaths have shown on occasion that there are incidents known where an officer readied his weapon but never had an opportunity to fire and defend himself due to a perpetrator simply going on the attack too quickly. The sensory and telemetry data for a weapon, even one which remains holstered, can shed light on the series of events that lead up to an attack on an officer, be it the audio (while still in holster) or the status of the safety or the status of the holster strap and snap, or the status of the officer's hand on or off of the gun, etc. All of this data aids an investigation in the horrific occurrences of attacks on on-duty police officers. The same data may likewise prove relevant for civilians.

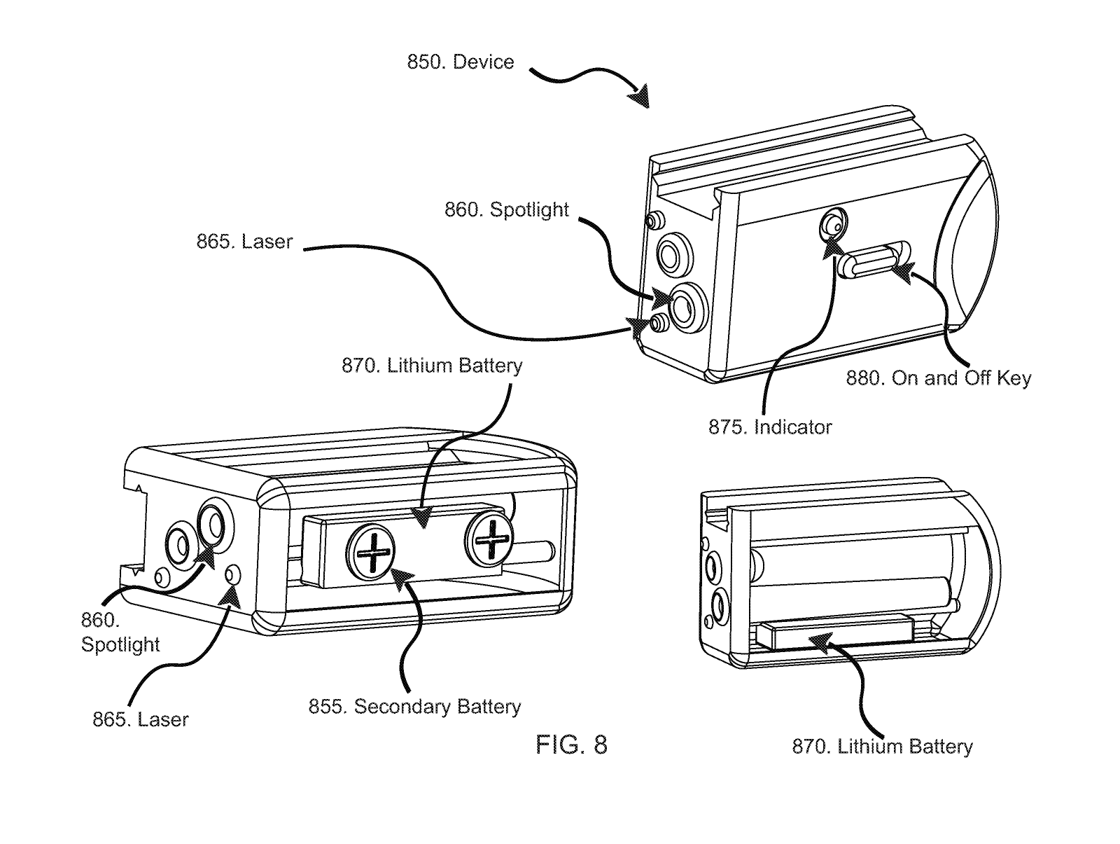

FIG. 8 depicts an embodiment of the device 850 as depicted with differing shapes and form factors and its varying components. Specifically depicted in conjunction with device 850 is a secondary battery 855 which, when provided, supplies dedicated power to the spotlight 860 and laser 865. For instance, the device 850 is configured in such a way that the spot light and laser may be utilized and draw power from the secondary battery 855 without depleting the power reserves of the primary battery 870 such that, even if the laser and spotlight are over utilized and fully deplete the secondary battery 855, the primary battery 870 will not be depleted by overuse of the laser and spotlight and may thus continue to provide power for the functionality of the device 850.

Also shown is indicator 875 to show or indicate how much power remains for the primary battery 870. The on and off key 880 is utilized to turn the spot light and laser on and off. In certain embodiments, the on and off key 880 is a multi-positional slide key where there are alternative embodiments for which the on and off key 880 is a push button toggle which has multiple states, such as laser and spot light off, laser and spot light on, laser on and spot light off or laser off and spot light on, control of a night-vision mode, etc. Multiple keys or multiple push-buttons may alternatively be utilized.

Further depicted are the physical form factor and shapes for device 850 with the inner components including; Camera, Microphone, Laser, Spotlight and Proximity sensor. There is further depicted the indicator battery charge lights on the Device and as shown the body and the physical key (On/Off) for Laser and spotlight. The camera and microphone are activated automatically by using proximity sensor according to this embodiment, thus there is no switch dedicated to their operation. For some embodiments, the camera and microphone cannot be switched off by the user, whereas other applications, activation and deactivation are permissible (for instance, for police use an always-on mode may be mandated whereas home-use may permit deactivation of the audio/video/telemetry recording).

Select embodiments utilize a battery threshold indicator which alarms if battery level falls below a minimum. Such an alarm may be a trigger sent to central operations at a police station or other monitoring station to indicate of a low battery status. In alternative embodiments, the device “pings” or checks in with a central operations center to indicate its status, including any events and battery status, and the central operations center alarms or triggers an event for field weapons which do not “ping” or check in after a pre-determined amount of time as per department policy.

It is conceivable that this data may also be used to aid a search for a person or officer missing but is known to have such a device.

For instance, a home owner with such a device mounted onto a personal weapon likely has no need for such triggers and alarms, however, a police officer which operates within the sphere of a larger police department, may be subject to policies and controls which require, for example, “always-on” monitoring and video and audio of a weapon that is de-holstered, and must therefore participate and adhere to the system which provides the necessary check-ins and status to avoid tampering.

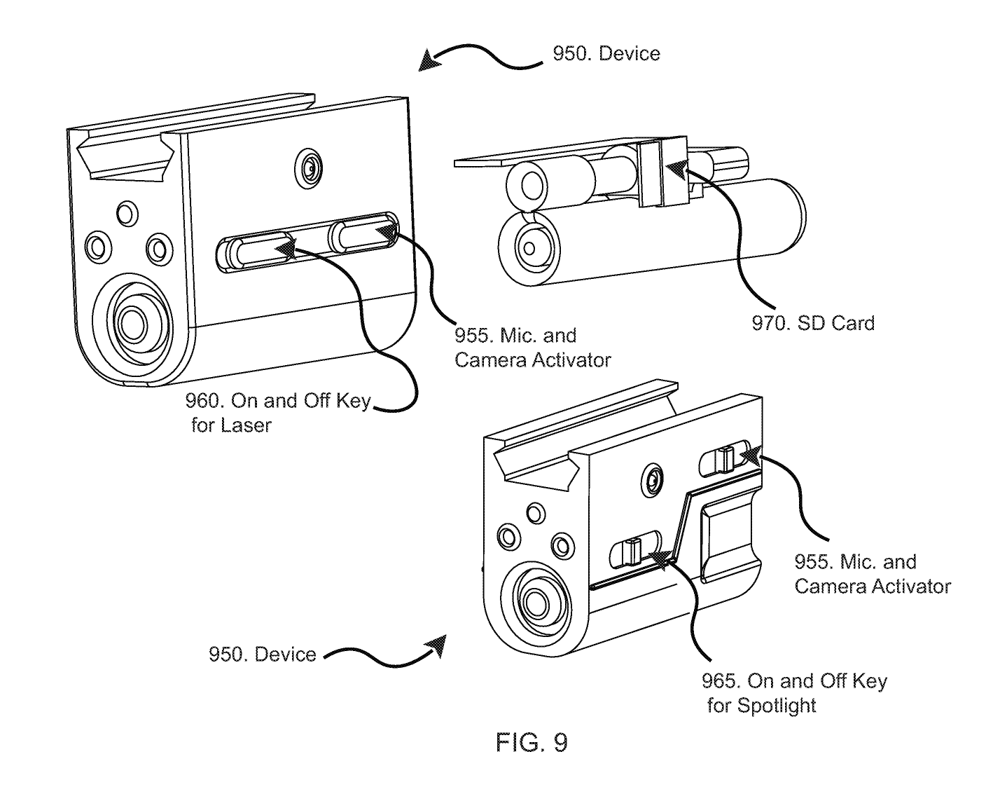

FIG. 9 depicts alternative embodiments of the device as depicted with differing shapes and form factors; Fig.9: Shows the device 950 having different switches or keys to activate the camera only or the microphone only. For instance, key 955 provides on and off toggle functionality to activate the camera and microphone. In certain embodiments, both the camera and microphone are activated simultaneously with key 955. In other embodiments, on and off key 955 for camera and microphone is a multi-positional slide key wherein other embodiments, the on and off key 955 is a push button toggle which has multiple states, such as video and audio off, video and audio on, video on and audio off or video off and audio on based on the given preferences of the user at the time. In other instances, the audio and video is not user configurable, such as with the always-on functionality described throughout, in which case the audio and video recording capabilities are controlled by the proximity sensor or other appropriate sensor. Likewise depicted is key 960 laser to turn on and turn off the laser. Key 965 is use to turn on and off the flashlight or spotlight. In alternative embodiments, the keys 960 and 965 are unified into a multi-positional key or a multi state toggle push button. Secure Digital card 970 (SD card 970) is a non-volatile memory card format developed by the SD Card Association (SDA) for use in portable devices which may be integrated into device 950 to capture telemetry data from the device 950 including audio, video, distance to object, time of day information, and so forth.

Different shapes and figures for Device embodiment shown, regards to capture the video, record voice, profiting by Laser beam for target aiming and spotlight for concealed weapons like pistol 9 mm. Device embodiment shown points to Self crimes defense circumstances and provide strong reasonable evidence. The 9 mm pistol is a common police force weapon and was tested with the prototype, however, it represents only one of many firearm and non-lethal weapon applications.

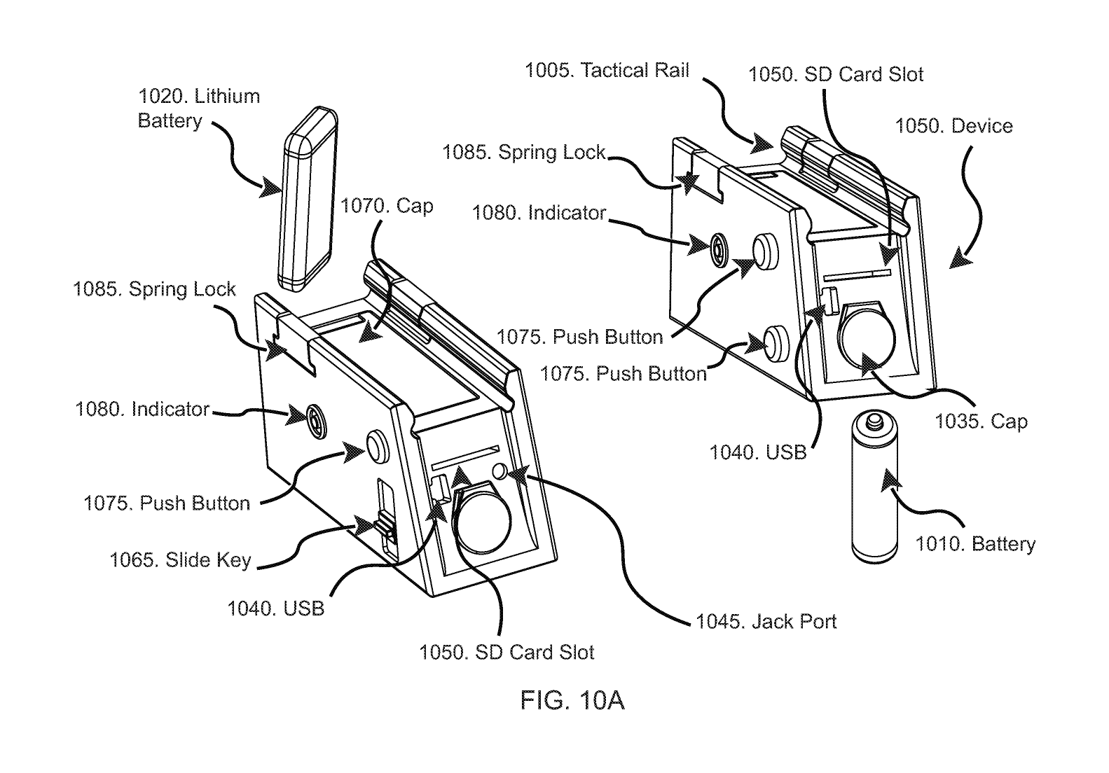

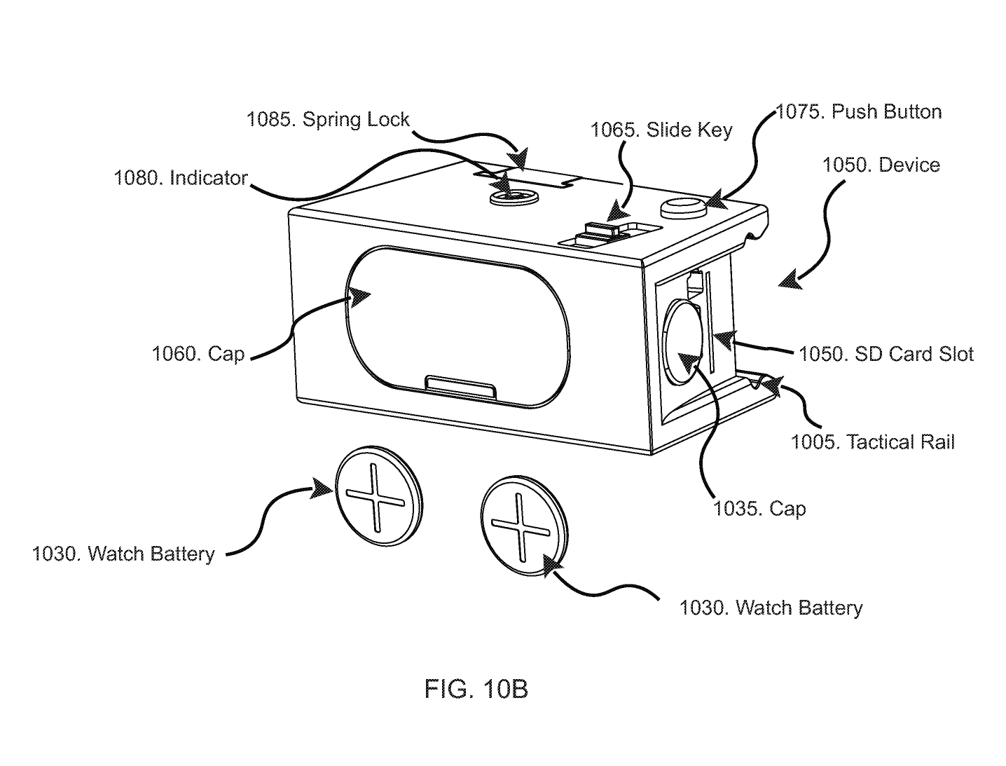

FIG. 10A depicts an embodiment of the device having laser and spotlight control mechanisms and FIG. 10B depicts an embodiment of the device having laser and spotlight control mechanisms.

Depicted here are multiple batteries integrated into device 1050. For instance, depicted here is battery 1010 for the spotlight integrated into device 1050. For example, battery 1010 may be a standard AAA or AA sized battery depending on the particular size and configuration of the device 1050. Battery 1020 depicts the primary battery, such as a lithium battery integrated into the device to power the telemetry capture capabilities of the device. Battery 1030 depicts a dedicated battery for the laser diode, which may be, for instance, a small watch battery for a laser diode having low power requirements.

Cap 1035 is depicted as a cover and latch to seal in battery 1010. It is contemplated that a standardized AAA or AA battery may be depleted more quickly by use of the integrated flashlight or spotlight, especially if utilized heavily or frequently, and thus, the cap 1035 permits quick and simple replacement for the user.

Universal Serial Bus 1040 (USB 1040) standardized interface (e.g., USB1, USB2, USB3, etc.) is an industry standard developed in the mid-1990s that defines the cables, connectors and communications protocols used in a bus for connection, communication, and power supply between computers and electronic devices such as device 1050. In another embodiment, a stereo jack port 1045 (e.g., an audio jack and port) may be utilized for both power and communications interface. For instance, commonplace in the market place are watches, phones, and other electronic devices capable of transmitting data via the stereo jack port 1045.

SD card slot 1055 provides easy access to the removable media, such as an SD card as is depicted here. Other storage circuitry may be utilized in conjunction with the described embodiments. In certain configurations, the memory is removable and user replaceable just as with a consumer camera. In other embodiments, an SD card slot 1055 is integrated into device 1050 but is not accessible to the end user, for instance, where the device is utilized in an always-on capacity such as with a police force and in which tampering must be avoided. For example, police department policy may prohibit officers from having access to the data or the SD card slot, and would therefore seek to procure a configuration of device 1050 for which the SD card slot and the SD card memory itself cannot be accessed or tampered with.

Depicted also is cap 1060 which covers battery 1030, such as a watch battery which may thus be replaced by an end user. Even with device configurations such as those utilized with a police force in which the officers cannot access the memory or turn off the device, the cap 1060 may nevertheless be user accessible to replace the battery for laser operation.

Further depicted is cap 1070 which provides access to the primary battery 1020, such as a lithium battery to power the device 1050 similar to those utilized in cellular telephones, smart phones, etc. Cap 1070 therefore provides access to the battery in those configurations which permit the user to power off the device or not utilize the devices telemetric data capture capabilities. In other embodiments where the end user is not permitted to select whether ore not the device 1050 is used, the cap 1070 is simply not provided and the primary battery 1020 integrated into device 1050 is not accessible and not user replaceable.

Depicted here slide key 1065 which permits the user to turn the laser and spotlight off, the laser on and the spot light off, or the laser and the spotlight on.

The way of Turning On/Off the laser and spotlight: there are some possibilities to turn On/Off Spotlight and laser; Sliding Button, Pressing Button and/or Pushing Button.

Data is recorded on mini SD card or internal non-removable solid state memory, the lithium Battery is charged by USB2 or USB3, etc. The Data can transfer by putting SD card in SD card reader or connect Device embodiment shown to computer by cable and USB port.

Push button 1075 is depicted which permits the on/off operation of the laser or the spot light or both in accordance with the various embodiments as was described above. Indicator 1080 is likewise depicted as described previously.

Tactical rail spring lock 1085 locks the device 1050 onto tactical rail 1005. For instance, the user may press the spring lock 1085 inwards to release the device 1050 from the tactical rail 1005. In certain embodiments the device 1050 is permanently affixed to the gun or to the tactical rail such that it cannot be removed by an end user, such as in the case where a police force policy prohibits removal of the device 1050 from the firearm.

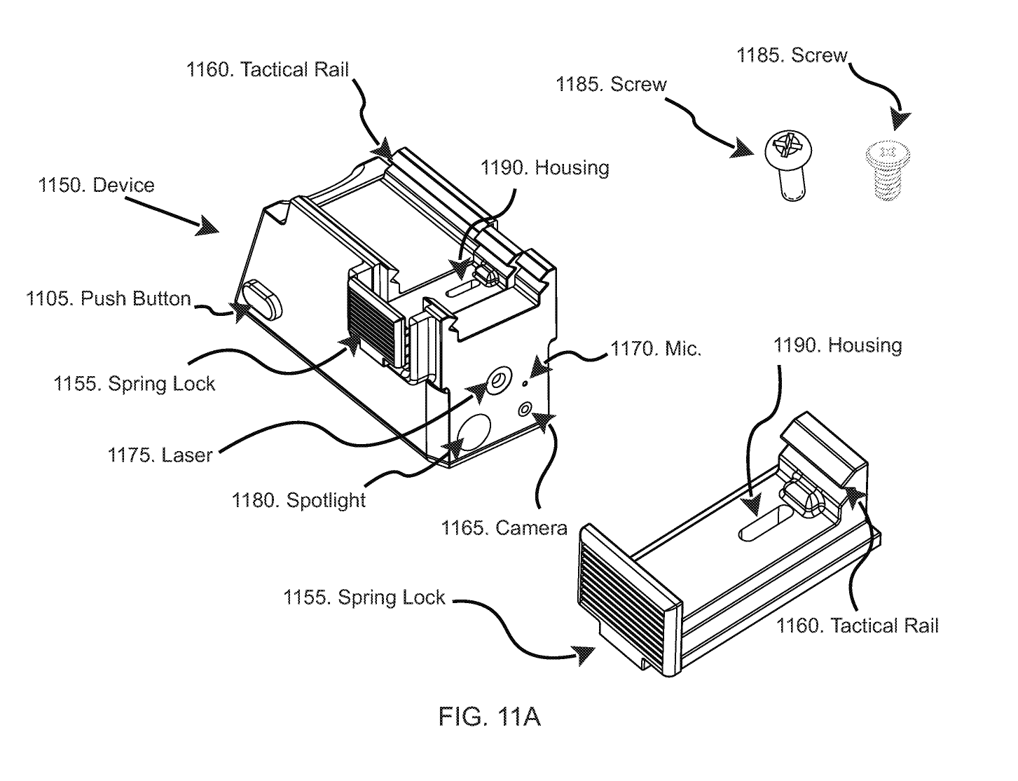

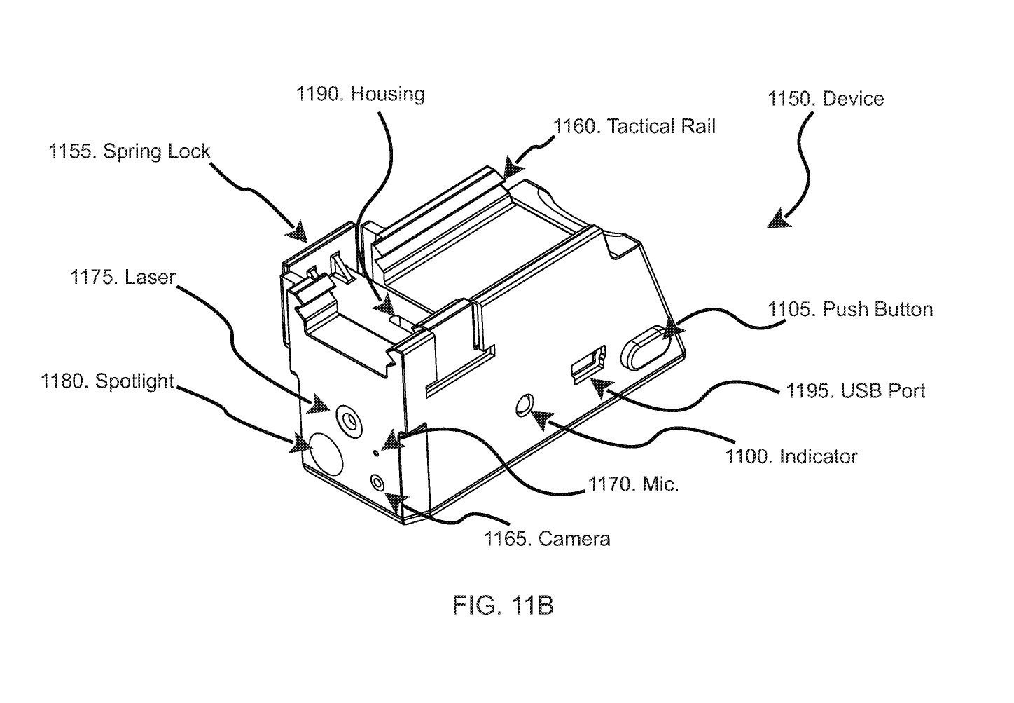

FIG. 11A depicts an embodiment of the device with a drawer and spring mechanism and FIG. 11B depicts an embodiment of the device with a drawer and spring mechanism.

Depicted is 1150 having affixed thereto a drawer and spring lock system 1155 which enables the device 1150 to be fixably attached to the tactical rail 1160 of the depicted firearm. Further depicted is camera 1165 and microphone 1170 embodied within the device 1150. Laser 1175 is additionally depicted along with spotlight 1180 as integrated within device 1150 according to the depicted embodiment. The drawer and spring lock system 1155 operates by a user pressing the drawer inward to align the longitudinal recessed groove of the drawer and spring lock system 1155 into a single groove such that it may receive a rib of the tactical rail 1160. When the drawer of the drawer and spring lock system 1155 is pressed inward, the drawer and spring lock system 1155 permits the entire device 1150 assembly to slide onto the tactical rail 1160 of the firearm, at which point the user may release the spring lock of the drawer and spring lock system 1155 to fixedly attach the device 1150 to the firearm via the tactical rail 1160.

Screw 1185 holds the drawer of the drawer and spring lock system 1155 through housing 1190 such that the drawer may slide laterally left and right on the drawer and spring lock system 1155.

Indicator 1100 depicts indicator which provides a readout of remaining power for the primary battery, such as a lithium battery and USB port 1195 depicts the USB interface to receive power and transmit data to and from the device 1150.

Push button 1105 provides an on/off toggle functionality for the laser and the spotlight of the device 1150.

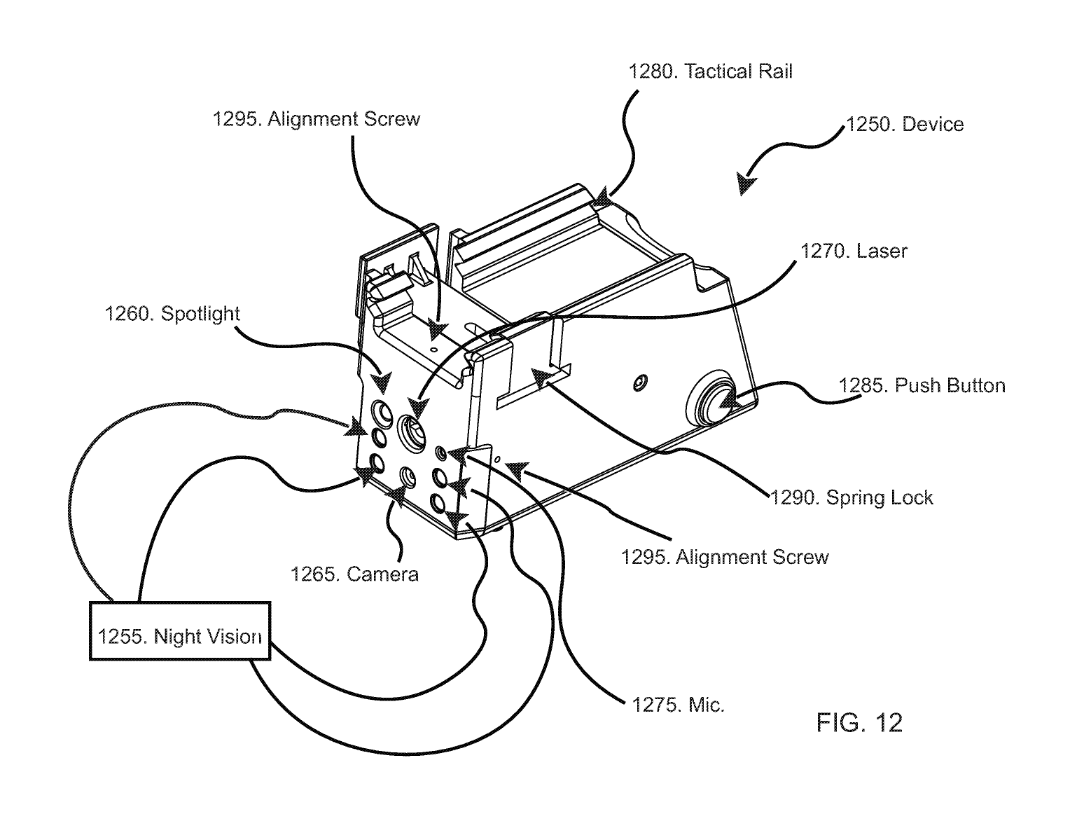

FIG. 12 depicts an embodiment of the device as prototyped with night vision video capture capability and other described features integrated therein;

Depicted is device 1250 having embodied therein night vision LEDs 1255 which emit light in the infrared range to illuminate objects, targets, human subjects, and other elements in a scene which is then captured by the infrared camera 1265. The infrared camera 1265 captures light in the infrared range when operated in night vision mode but may also capture light in the visible range, for instance, when the scene is illuminated by ambient light or illuminated by spotlight 1260 which emits light in the visible range. Laser 1270 is additionally depicted and may emit light in the visible range or in the infrared range. Microphone 1275 is further depicted which captures audio and sound information from the environment surrounding the device 1250 during operation.

Push button 1285 is depicted which provides on/off for the laser and/or the spot light. Spring lock 1290 and tactical rail 1280 are further depicted in this embodiment. Alignment screws 1295 are further depicted which enable an end user to zero the aim of the laser 1270 of the device 1250 once installed by correcting for lateral left/right and vertical up/vertical down such that the laser point on target is zeroed to the alignment of the muzzle of the firearm.

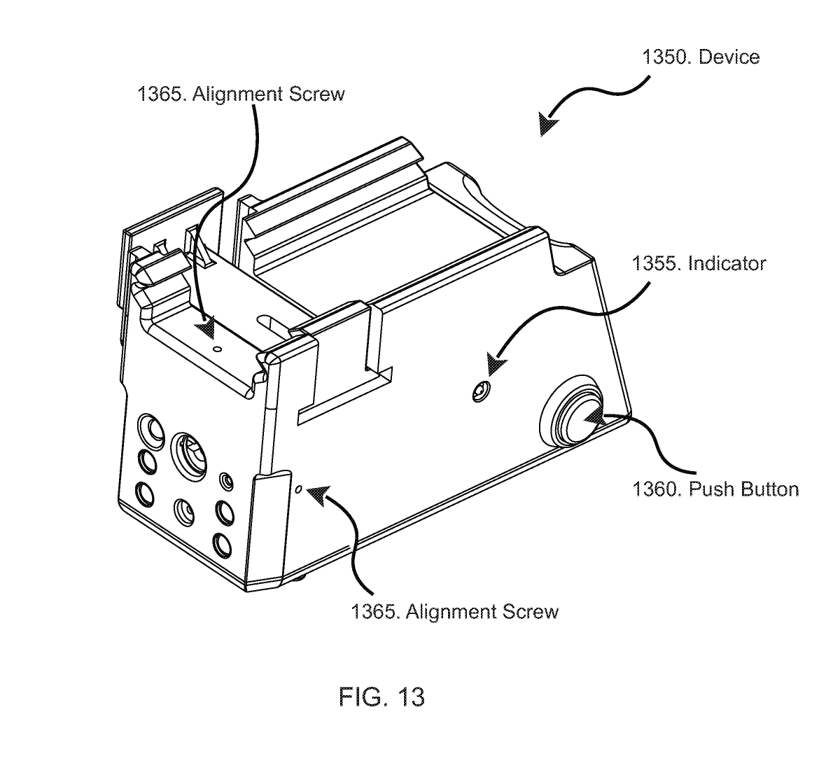

FIG. 13 depicts an embodiment of the device as prototyped with described functionality;

Device 1350 has integrated thereupon the indicator 1355 which provides a readout of the remaining power for the device 1350 as powered by the primary battery, such as lithium battery. Push button 1360 is depicted which provides on/off functionality for the laser and/or spotlight and 1365 depicts the alignment screws to zero the aim of the laser on target.

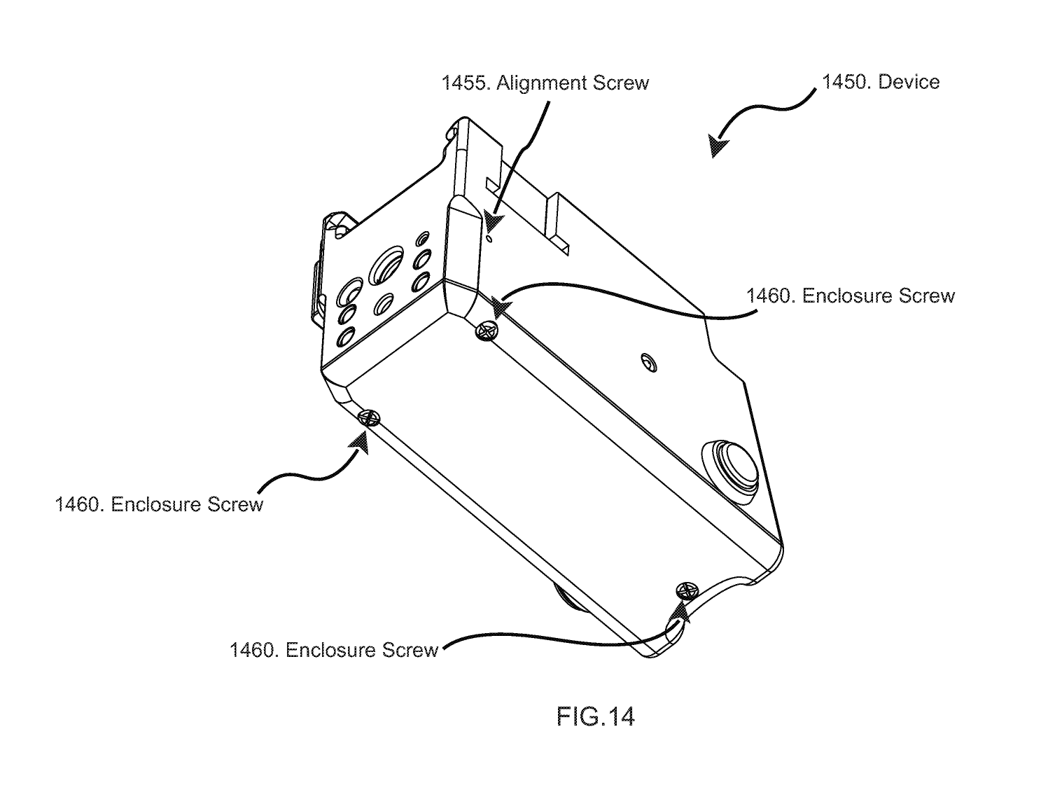

FIG. 14 depicts an embodiment of the device having a cap that can screw, glue or hang and fix upon the weapon with grips arms;

Device 1450 is depicted having integrated thereupon the 1455 alignment screws to zero the aim of the laser pointer for target acquisition. Enclosure screws 1460 are depicted which fasten the bottom enclosure face to the device's 1450 enclosure via grip arms or rails, such that the device 1450 may be serviced if necessary, for instance, providing access to the internal components of the device 1450 where such servicing is permissible according to the police department or municipality policies. For example, it is contemplated that end user/consumer devices may be field serviceable whereas certain police departments or other use cases may not permit field servicing where tampering is of concern or where permitting servicing would be against policy.

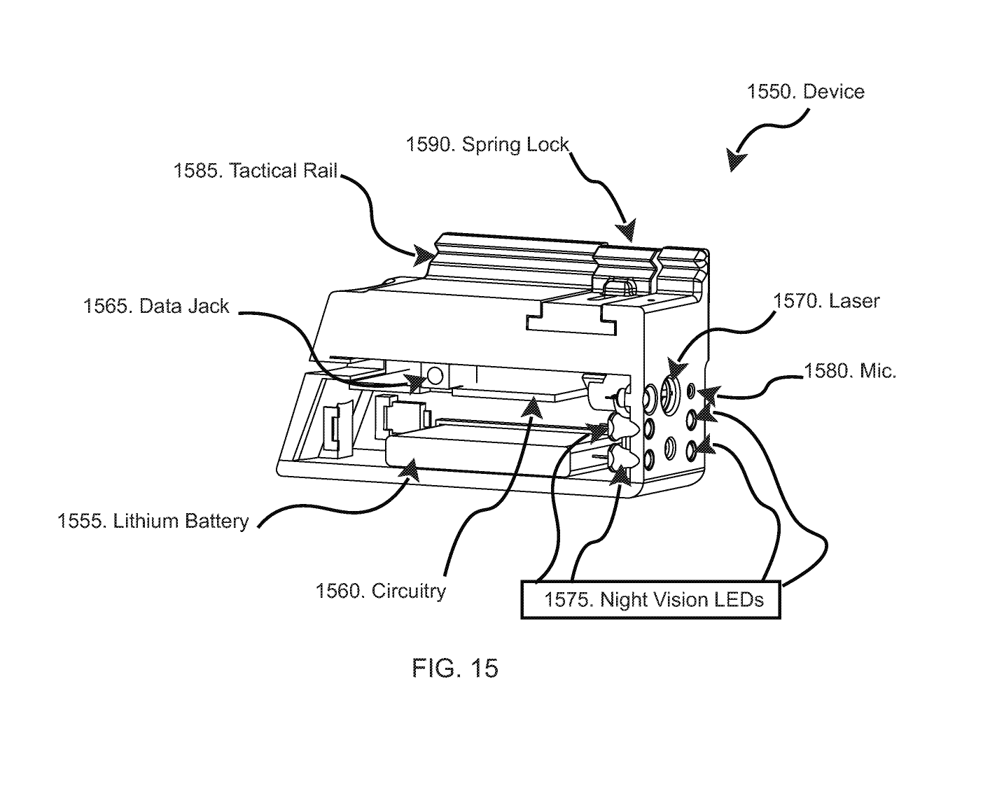

FIG. 15 depicts an embodiment of the device in a section view;

Device 1550 is depicted here having primary battery depicted as lithium battery 1555 to power the device's 1550 functionality. Circuitry 1560 is depicted internal to device 1150 to provide execution capability of the device's 1150 software and firmware functionality. Circuitry 1560 may be a system on a chip (SOC) or a processor and memory configuration, field-programmable gate array (FPGA) (e.g., an integrated circuit designed to be configured by a customer or a designer after manufacturing), or other programmable circuitry in support of the software and firmware functionality of the device 1550.

Data jack 1565 provides a data interface into device 1550. Laser 1570 is again depicted here along with the night vision LEDs 1575 and microphone 1580. Tactical rail 1585 is depicted as is spring lock 1590.

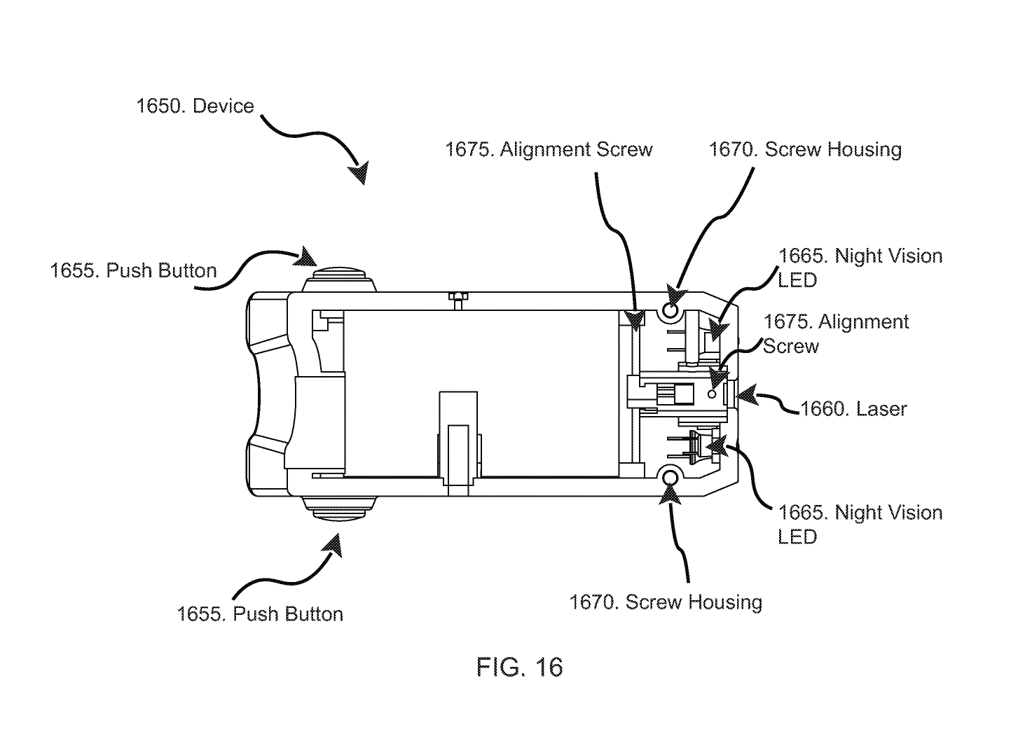

FIG. 16 depicts an embodiment of the device in a top section view;

Device 1650 is depicted here having integrated therein push button 1655 to provide on/off capability to the laser 1660 and/or the spot light. Night vision LEDs 1665 are depicted also to illuminate a scene, target, object, etc. in the infrared range such that the scene may be captured via an infrared camera.

Screw housing 1670 are depicted providing assembly points for the device 1650 enclosure at manufacture. Alignment screws 1670 provide alignment means to zero the laser to the target.

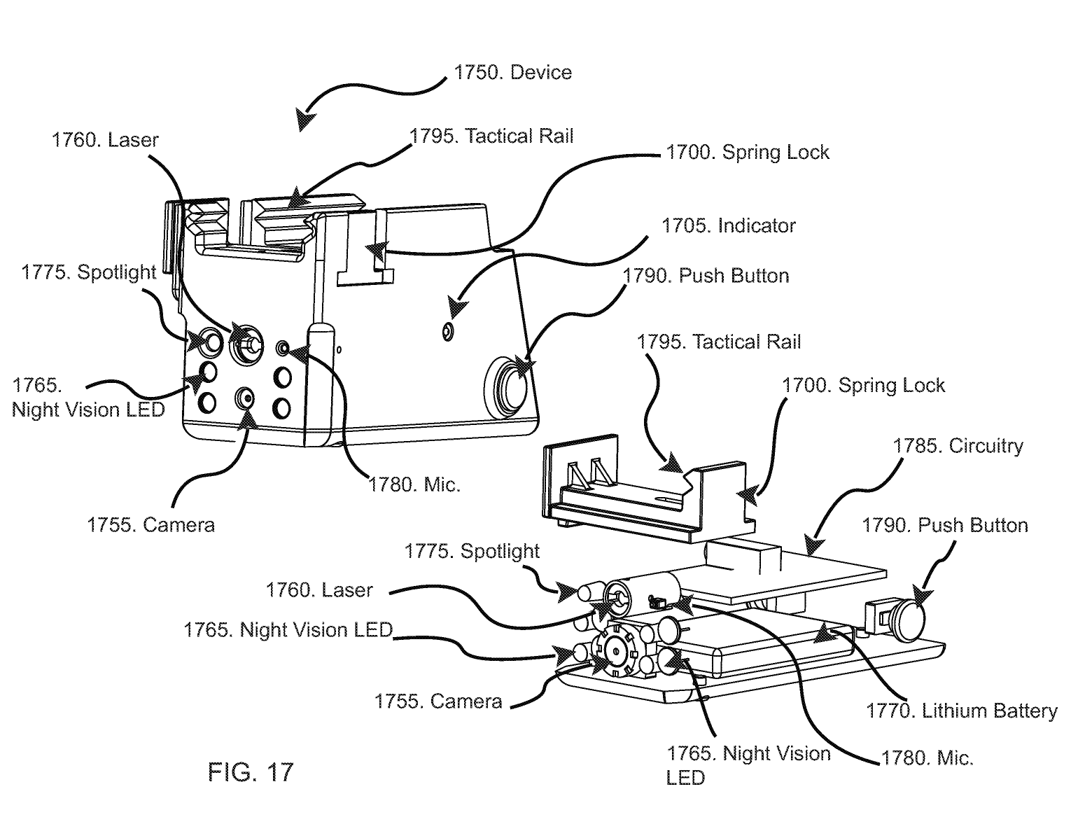

FIG. 17 depicts an embodiment of the device with an inner components view;

Device 1750 is depicted here having integrated therein camera 1755 enabled to capture still and moving imagery from a scene in a visible light range (e.g., via RGB camera) or in an infrared range according to operation of the device 1750 mode. Laser 1760 is depicted again and Night vision LEDs 1765 are likewise depicted.

Lithium battery 1770 (e.g., to operate as the primary or solo battery) is depicted by which its remaining power may be determined or observed by a user via indicator 1705. Depicted further are spot light 1775 and microphone 1780. Device circuitry 1785 is again depicted having processing circuit(s) and memory to enable the software and firmware capabilities of the device. Push button 1790 is depicted to provide on/off capabilities to the laser and the spotlight and the tactical rail 1795 is again depicted having the spring lock 1700 integrated thereupon to fixably lock or latch the device 1750 to a firearm's tactical rail receiver.

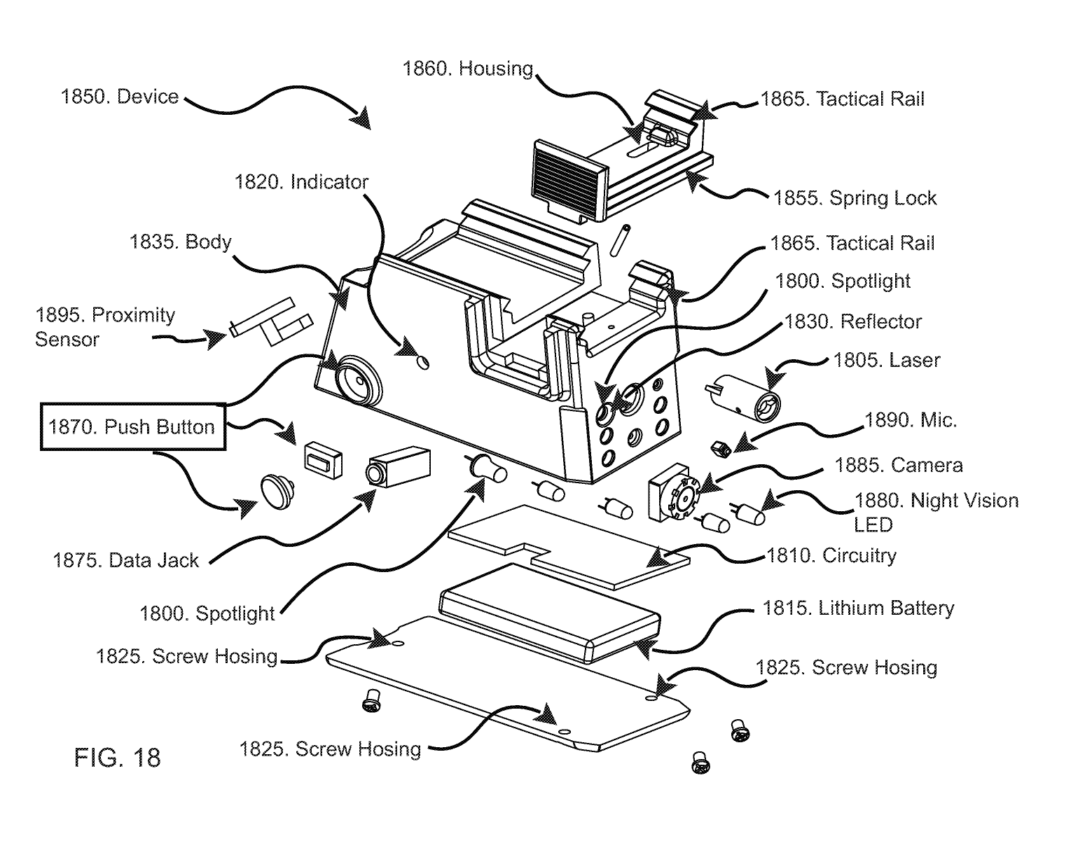

FIG. 18 depicts an embodiment of the device in an exploded view;

Device 1850 is depicted here having the spring lock 1855 and the housing 1860 for the spring lock 1855. Tactical rail 1865 is depicted in alignment with the spring lock 1855 and housing. Push button 1870 provides on/off capabilities for the device 1850 features and data jack 1875 provides a data interface. Night vision LEDs 1880 and spotlight 1800 and camera 1885 operate to illuminate and capture imagery from the scene while microphone 1890 captures ambient noise and audio. Laser 1805 provides pointing/aiming functionality, illumination functionality, depth determination capability, etc.

Proximity sensor 1895 may be utilized to initiate or trigger device features, such as starting to record and archive audio and video at the device 1850 in conjunction with the device's circuitry 1810, in which the device is powered by the lithium battery 1815. Indicator 1820 provides a readout or indication of remaining power for the lithium battery 1815 according to the depicted embodiment.

Screw housing 1825 are depicted for fixing the bottom plate to the device 1850 enclosure housing at assembly or servicing.

Reflector 1830 is depicted in this embodiment to better aim and direct light emitted from spotlight 1800 so as to make illumination of a scene more efficient with the available light emitted.

Body 1835 is depicted here providing the enclosure or housing for the device 1850 as a whole.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the invention is therefore determined in reference to the appended claims, along with the full scope of equivalents to which such claims are entitled.

What is claimed is:

1. A method executing within a device having at least a processor and a memory therein and being physically coupled to a weapon, wherein the method comprises:
operating a proximity sensor at the weapon, the proximity sensor to trigger an activation event upon removal of the weapon from a weapon holster;
detecting the activation event and triggering event archiving;
archiving event data by storing event data to the memory of the device; and
uploading the event data to a remote storage separate and distinct from the device.

2. The method of claim 1, wherein the weapon is one of a lethal or a non-lethal weapon.

3. The method of claim 1, wherein the weapon is selected from the group of weapons comprising:
a pistol;
a rifle;
a non-lethal firearm;
a non-lethal stun gun; and
a non-lethal mace or pepper spray.

4. The method of claim 1, wherein the method further comprises:
triggering a second event upon firing or discharge of the weapon.

5. The method of claim 1, wherein triggering event archiving comprises triggering the capture, recordation, and storage of at least audio via a microphone or audio capture device, video via a video capture device, and one or more telemetry data elements sensed at the device.

6. The method of claim 1, wherein the method further comprises one or more telemetry data elements sensed at the device selected from the group comprising:
device orientation;
device direction;
device g-forces;
device firing or discharge status;
device safety mechanism status;
device holster status;
device de-holster and re-holster time;
device user contact or no-contact status;
device temperature;
device GPS or geographic location data;
device battery status;
device time since check-in status;
device time since last charged status;
device data upload and synchronization status; and
device wireless communication status.

7. The method of claim 1, further comprising:
triggering upload of audio, video, and event telemetry data wirelessly to a remote location upon connection with the remote location without requiring user intervention.

8. The method of claim 1, further comprising:
pinging a central location which is remote from the device and providing status of the device including at least battery indicator level;
wherein the pinging of the central location resets a time since last check-in for the device.

9. The method of claim 8, wherein failure to ping the central location within a pre-determined time threshold triggers an alarm at one or both of the central location and the device.

10. A device capable for mounting to weapon, the device comprising:
a proximity sensor to trigger an event upon change in status of the weapon from a holster or to a holster;
an audio capture device;
a video capture device;
a solid state memory to store captured audio, video, and event telemetry data; and
a wireless communications interface from the device to a remote location having storage capability distinct from the device.
